(19) United States
(12) Patent Application Publication
(10) Pub. No.: US 2003/0003433 A1
(43) Pub. Date: Jan. 2, 2003

(54) Method and system for constructive, modality focused learning

(75) Inventors: Mark D. Carpenter, Austin, TX (US); Mary L. Schenck, Austin, TX (US)

Correspondence Address: HUGHES & LUCE LLP, Suite 2800, 1717 Main Street, Dallas, TX, 75201, US

(73) Assignee: Ignite, Inc.

(21) Appl. No.: 09/895,819

(22) Filed: Jun. 29, 2001

(51) Int. Cl. G09B 7/00

(52) U.S. Cl. 434/323

(57) ABSTRACT

A method and system for performing constructive, modality-focused learning, includes the steps of storing a collection of multi-media content segments in a database, the multimedia content having an associated learning modality tag profile. The invention then assigns a learning modality proclivity profile to a learner for reflecting the learning modality proclivity demonstrated by the learner. The learner is presented for selection by the learner the collection of multi-media content segments for responding to said constructive learning challenge. The system presents to the learner a constructive learning challenge, the constructive learning challenge formed so as to demonstrate the accomplishment of predetermined learning objectives and require the learner to construct a result. The method and system adapt the learning modality proclivity profiles and the learning modality profile tag in response to the demonstrated proclivity of the learner in accomplishing the predetermined learning objective and constructing the desired result. The invention further permits verifying the accomplishment of said predetermined learning objectives and the construction of said desired result.

This application claims priority of U.S. Provisional Application Serial No. 60/215,211, filed Jun. 29, 2000 entitled “System and Method for Evaluating an Individualls Learning Abilities and Customizing and Presenting a Curriculum for that Individual According to Their Learning Ability,”, and is incorporated herein by reference in its entirety.

### BACKGROUND OF THE INVENTION

Today, educating students in classrooms primarily occurs through the use of textbooks. Generally, however, a textbook is a static, heavy, boring, two-dimensional and inefficient way to convey information. Moreover, a textbook can generally do very little in the way of teaching students important skill. Textbooks also are not capable of appealing to broad scope of learners who may have different optimal learning modes than through reading printed text. Because most textbooks use the written word, they preferentially address only the linguistic learning style or modality. The textbook can only be slightly expanded, via the use of graphs and charts to appeal to the student having proclivities toward the mathematical or logical modalities. Accordingly, students who process information best via the auditory, musical kinesthetic modalities can find the textbook to be an essentially non-useful learning tool.

Another limitation associated with the use of textbooks relates to their being static and not dynamic. Often times they are out of date before their publication and disseminated to classrooms. The expense associated with updated or providing supplemental can be prohibited for the typical classroom, public or private educational environment.

A fundamental aspect of textbooks, therefore, is their failure to engage a significant portion, if not a majority, of classroom students in the learning process. Textbooks generally must be the same for all classroom learners. The textbook, without considerable expense, cannot adapt or be unique for each learner. Again, this limitation is especially troublesome for the student who processes information in ways other than those of other learners in the same classroom.

Another limitation associated with textbooks is their inability to generate information relating to their use by the students. Of course, workbooks with fill-in-the-blank types of inputs or other types of written responses in textual material have existed for some years. However, the ability to provide detailed, meaningful indication of progress the student makes in the classroom environment has not been possible through the use of the traditional textbook. Clearly, many textbooks provide for chapter review questions and problems at the end of specific chapter or section. Textbooks, however, provide no way to test whether a student has mastered and can effectively use new information.

Another limitation of textbooks derives from their not providing any gating function. A gating function can assure that the student does not move to additional new material until first mastering of the material with which he currently deals. Failing to gate the student may prematurely confront additional new material while the student glossing over or not learning currently dealt with in material such a situation, that may be essential to understanding the new material. As a result, a student may progress through a textbook, increasingly unable to master new material. In courses such as mathematics or technical subjects where progress critically depends on mastering progressively difficult material, the result can be a growing difficulty in learning new material. A gating function helps to avoid this result.

Still another limitation of existing ways of presenting information is that they do not give the user effective ways to create projects or construct a learning experience based on presented information. The textbook facilitates a teacher presenting to learners information in terms of statements, facts, or questions. Only with isolated, specially crafted, projects can the learner be held responsible for using statements, facts, or answers for the purpose of accomplishing integrated, multi-faceted tasks or projects. A textbook that can only present statements, facts and questions for general classroom use cannot effectively assist in the construction of integrated learning process that at the same time (1) assures that certain learning objectives are attained and (2) calls for the learner to construct a desired result.

Attempts have been made to translate textbook information into a software environment either for use on-line or thru computer assisted training packages. The problem with the porting of textbook content to an on-line environment remains that the information presentation suffers from the above-stated limitations with the simple porting of textbook content, there can be little in the way of having a rich multimedia learning experience. Nor is there a way to determine that the learner has learned the necessary subject matter. With simply translating textbook content to a software environment, there is also no feedback loop.

U.S. Pat. No. 6,186,794, entitled “Apparatus for Interactive Adaptive Learning by an Individual through at least one of a Stimuli Presentation device and a User Receivable Display” (the “'794 patent”) shows a system that seeks to analyze the particular learning style of a learner. The system attempts to assess the type of learner that a person may be, but fails to take the process any further than learner analysis. The learning is assessed in a textual manner to determine his learning style, the information describing the learners style may later be placed in a software program and graphical user interface, for example, but no such suggestion appears in the '794 patent. Moreover, the '794 patent shows the use of right or wrong answers in determining the learning style of a particular learner. The right or wrong answers can unjustly or inaccurately bias or affect the use of information that suggests the learning style a learner demonstrates. Since learners may effectively demonstrate more than one type of learning style, dealing in terms of simply right or wrong answers in assessing a learning style may produce an incomplete understanding of a learners abilities.

### SUMMARY OF THE INVENTION

The present invention overcomes the limitations of existing educational methods and system by providing a web-delivered interactive educational curriculum delivery platform that utilizes two-way adaptation to deliver user specific content based on individual learning styles. A core collection of tagged rich multi-media content, stored on a server, is presented to the user through a browser. Both the content and user are assigned a learning style profile. Through a series of user interactions with this media the present invention adapts both the content and user profiles to present content organized to an individual users learning style. The system has a built in strategy for progressing the user through the curriculum. In addition, information is provided to teachers and parents regarding the individual users learning pathways.

According to one aspect of the invention, there is provided a method and system for performing constructive, modality-focused learning, includes the steps of storing a collection of multimedia content segments in a database, the multimedia content having an associated learning modality tag profile. The invention then assigns a learning modality proclivity profile to a learner for reflecting the learning modality proclivity demonstrated by the learner. The learner is presented for selection by the learner the collection of multi-media content segments for responding to said constructive learning challenge. The system presents to the learner a constructive learning challenge, the constructive learning challenge formed so as to demonstrate the accomplishment of predetermined learning objectives and require the learner to construct a result. The method and system adapt the learning modality proclivity profiles and the learning modality profile tag in response to the demonstrated proclivity of the learner in accomplishing the predetermined learning objective and constructing the desired result. The invention further permits verifying the accomplishment of said predetermined learning objectives and the construction of said desired result.

A technical advantage of the present invention is that it provides information in a tailored way for the particular type of learning modality proclivity of a given learner. The present system and method address all relevant types of learning modalities that are consistent with the material being presented. Upon determining that a learner has a particular type of learning modality proclivity, the present system provides to the learner, at the beginning of a learning session, information in a manner most appropriate for the learning modality proclivity of the learner. The order in which the system presents material to learner particularly benefits the learners by first addressing the learning modality proclivity. The remaining material or media which may be more easily used by learners with other learning modality proclivities are provided to the learner, however, after the most accessible mode is first used.

A further technical advantage of the present invention is that it uses accepted adaptive learning algorithms for determining the modality proclivity that a person demonstrates. This facilitates both the understanding of the type of material that might be best presented to a learner, as well as the proclivity of the learner, him or himself.

Still another technical advantage of the present invention is that it has the ability to expand beyond the presently-accepted major areas of learning modalities. The modalities for one embodiment may include the auditory, linguistic, kinesthetic, musically, mathematical or logical modalities. The preferred embodiment of the present invention makes use of these five learning modalities. The present invention, however, has, in addition, the ability to expand to many other learning modalities that a learner may demonstrate. Therefore, the present invention has the ability to be useful for an ever-expanding array of different types of learners exhibiting many different types of intelligences.

The present invention possesses the technical advantage of providing information in a constructivist manner. That is, it presents information in a manner more consistent with how a learner might learn information outside of a classroom environment. By presenting a particular challenge and an array of tools to address the particular challenge, the present invention present material in a manner consistent with the individual learner's modality proclivity.

Another aspect of the present invention is that it is student centric, as opposed to classroom or teacher centric.

This permits the presentation of information in ways that are most useable by each student on an individual basis. By addressing each student on an individual basis, the present invention enhances the general level of understanding and can enhance the community of a classroom. Moreover, because the teacher of a classroom is viewed as increasingly addressing the individual needs of each student, the learning processing is facilitated because of the increased care or attention that the learner receives through the assistance of technology. The teacher has the ability to understand and to respond to the modality proclivities of students. Having thus identified the modality proclivities of an individual student, the continued attention yields continued rewards of pursuing the educational process to each individual student. As result, the present invention material enhances benefit to the student, the benefit to the class, and the professional rewards of the teacher.

Yet another technical advantage of the present invention is the use of continued feedback and continued monitoring to make certain that the learner experiences all modalities of learning.

The present invention ensures a much more robust learning experience at the individual level. The present invention identifies that modalities of learning and all relevant subject matter to be learned by the learner. This makes certain that the learning process is as complete as possible. What the student experiences are also recorded via reports for use by the teacher as well as the parents or guardians of children learners. This further enhances the learning process to the benefit of the students and the parents as a whole.

Still another technical advantage of the present invention is that it provides for the real time or dynamic updating of content that a student may use in the constructive learning process.

Still another technical advantage of the present invention is that it provides for a learning process that is non-linear versus the linear or serial learning methodology of a textbook.

By facilitating the testing of learning objectives and construction of desired results in real time, the present invention facilitates the learner's drawing information from different sources in a non-linear fashion.

Another technical advantage of the present invention is the verification that in the learning process the student has mastered content sufficient to satisfy standardized aptitude tests at any desired level. For many schools, state or local aptitude test showing competency in mathematics, linguistics, history and other information must be mastered for the student to progress to the next educational level. The present invention assures that information is provided consistent with stated standardized learning objectives. The present invention, therefore, provides an additional learning tool to help students meet the minimum learning requirement. In particular, by providing the content through learning modality consistent with a student's measured learning modality proclivities, the present invention enhances or improves the ability of the learner to master the material. this will significantly assist the learner to successfully progress in today's educational system.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 illustrates an architectural diagram demonstrating one embodiment of the present invention;

FIG. 2 demonstrate graphically essential characteristics of a learner modality proclivity measure;

FIG. 3 depicts the different choice and completion characteristics that may demonstrate a certain learner modality proclivity profile in the formation of a constructive solution to a particular challenge according to the teachings of the present invention;

FIG. 4 shows a set of media modality profile tags for relating to the learner modality proclivity profiles that one embodiment of the present invention employs;

FIG. 5 characterizes the process of adapting a learner modality proclivity profile through the use of a media modality profile tag

FIG. 6 typifies the process of adapting a media modality profile tag through the use with a learner modality proclivity profiles

FIG. 7 depicts the various media modality profile tags that different types of media may merit;

FIG. 8 illustrates the varying learner modality proclivity profiles that different learners may demonstrate;

FIG. 9 describes graphically the occurrence of adaptation that the present invention provides;

FIG. 10 provides a sample result of an adapted media modality profile tag and an adapted learner modality proclivity profile;

FIG. 11 details the process flow occurring in a student interaction made possible through the present invention for enhancing the learning process;

FIG. 12 outlines the different levels of content employed by the present invention for generating relevant media modality profile tags;

FIG. 13 shows an exemplary assemblage of different forms of media, each having an associated media modality profile tag, for generating a constructive learning experience module;

FIGS. 14 through 18 illustrate a series of graphical user interfaces that a learner may use in accomplishing a predetermined learning objective and constructing a desired result consistent with the teachings of the present invention; and

FIGS. 19 through 22 provide a further series of graphical user interfaces depicting the results of the verification of accomplishing predetermined learning objectives and constructing a desired results according to the teachings of the present invention

### DETAILED DESCRIPTION OF THE PREFERRED EMBODIMENT

FIG. 1 illustrates an architectural diagram to demonstrate one embodiment of the invention of the system and method of the present invention. In particular, system architecture 10 includes media store 12, which is drawn upon to create an instance of the adaptive learning system 14 of the present invention. Adaptive learning system 14 includes presentation layer 16 which adjoins business launcher adaptation layer 18 which draws upon database 20. Database 20 is connected or communicates with media store 12. Presentation layer 16 communicates via the internet as indicated by internet cloud 22 with a school or other learning site 24. Learning site 24 may includes either within it or may communicate with a remote computer 26 that provides to a learner content that the present invention may provide.

The present invention is all enabled via the internet or web. This permits the adaptation of information rapidly as well as the imposition of business logic and the maintenance of a complete data bases supporting the particular learning objectives if a wide variety of users.

Referring to FIG. 1, from a system standpoint, the present invention provides the java base to a system such that all interaction with the data base, all of the process goes through the Enterprise Java Bean layer of the present invention, which is a relatively common design for the purpose of implementing a server layer in communication with a user via the internet.

Consistent with the architecture in FIG. 1, when a student logs in at Block 26, for example, the communication is authenticated via the internet to the learning system 14. The information relating to the student is served via media store 12 to the presentation layer. At the presentation layer, the records relating to the student, his progress and the upcoming or potential challenges that he may undertake are all presented at the presentation layer using business logic layer 18 and data base, served up data base layer 20, via internet 22 into the school at which point the school 24, at which point the student at computer 26 may respond appropriately.

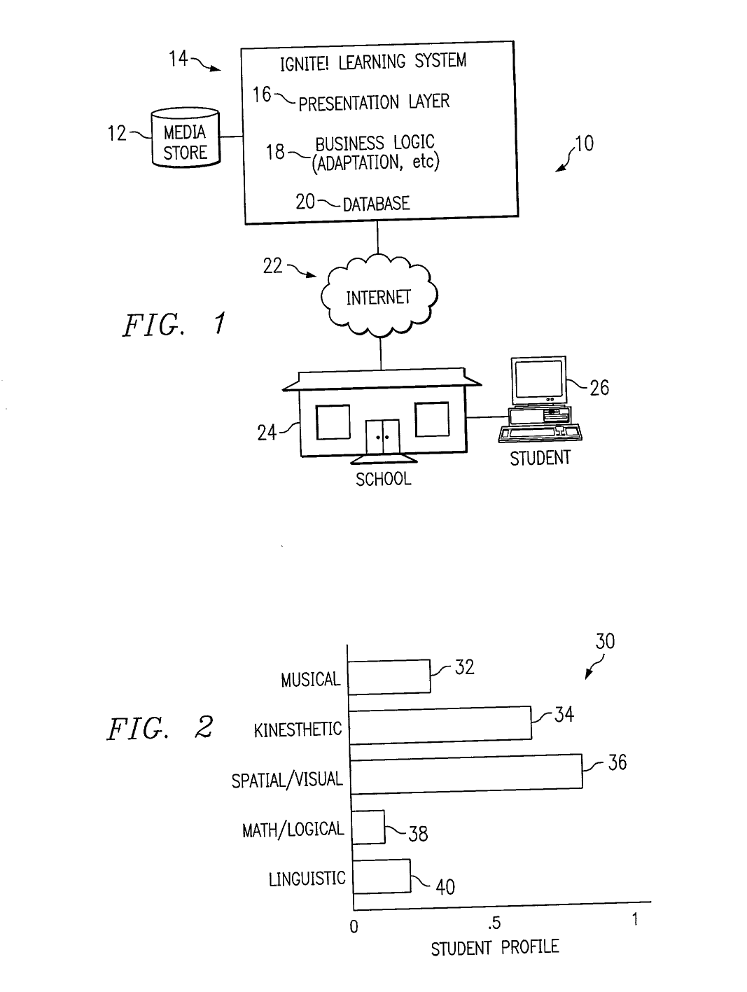

Diagram FIG. 2 shows diagrammatically a student profile to indicate the different learning modalities for which a particular student may have a unique proclivity. In particular, diagram 30 of FIG. 2 shows musical modality proclivity as bar 32, kinesthetic modality proclivity as bar 36 and spatial/visual modality proclivity as bar 38. Moreover, a mathematical or logical modality proclivity is shown by bar 40, while linguistic proclivity is indicated via bar 42. Although the preferred embodiment addresses five modalities of learning, the present invention may incorporate a larger number of such modalities. This would permit the indication of different learning modality/proclivities of a given student.

As can be seen in diagram 30 of FIG. 2, the individual or example student appears to have a greater proclivity to the spatial/visual learning modality. Second to the spatial/visual learning modality, the student shows a higher proclivity to the kinesthetic modality of learning as indicated by bar 36 not being of as great a magnitude in the range from 0 to 1 as the spatial/visual learning modality. Still, the spatial/visual learning modality measure 36 is significantly higher than that demonstrated in the musical learning modality at bar 32, or the math/logical modality 40 or linguistic modality at bar 42. In combination, the measured learning modality proclivities from a learning modality proclivity profile for a given learner.

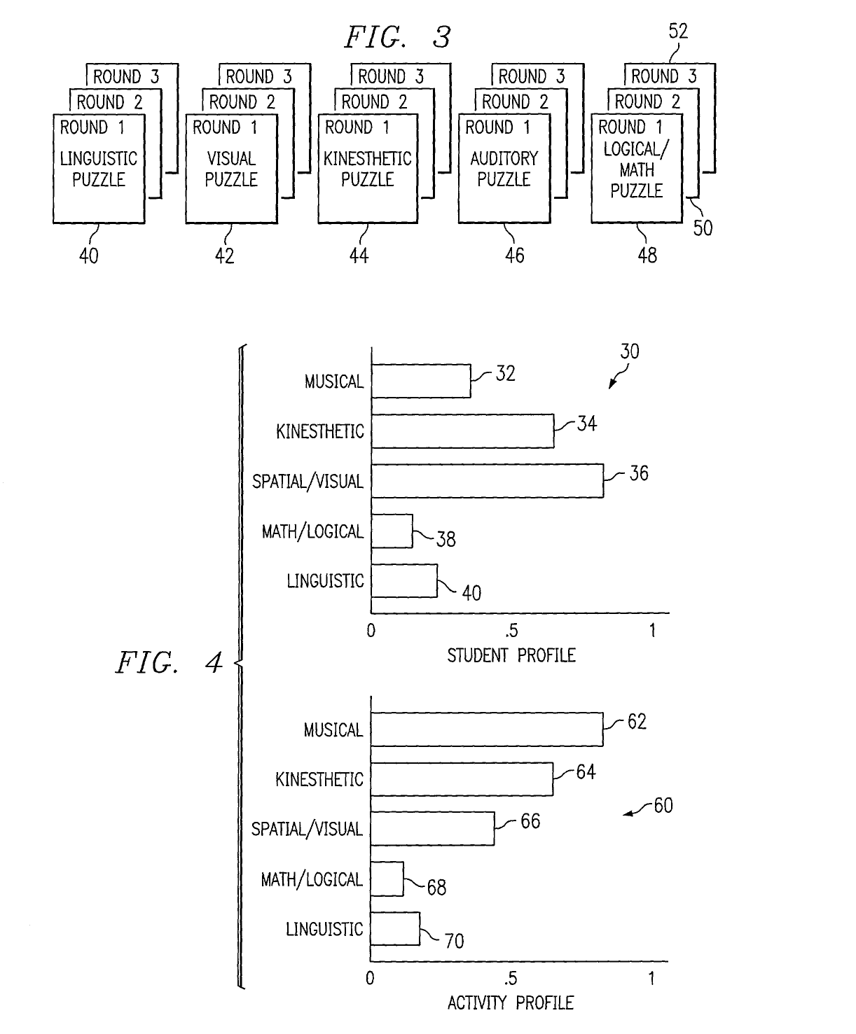

FIG. 3 illustrates that learning modality proclivities demonstrated through student choice and the completion of designed activities. In particular, the different learning modalities that might appear in a puzzle may include a linguistic puzzle 40, and an individual puzzle 42. In addition, a kinesthetic puzzle 44, an auditory puzzle 46, and a math/logical puzzle 48 may also be provided to the learner.

Through successive rounds as indicated, for example, second round for math/logical puzzle 50 and as further indicated by round 352 for math/logical puzzle 48, the student indicates increasingly his or her modality proclivity for a particular type of problem.

FIG. 4 provides profile diagram 60 to show the modality proclivity associated with actions made by a particular student.

For example, in a particular activity, it may be that a student's actions indicate a proclivity toward the musical modality as indicated by bar 62, followed with a high kinesthetic proclivity as demonstrated by kinesthetic bar 64.

Moreover, some spatial/visual proclivity may be demonstrated by bar 66, while math/logical modality proclivities are not shown, nor are linguistic modality proclivities as bars 68 and 70 indicate.

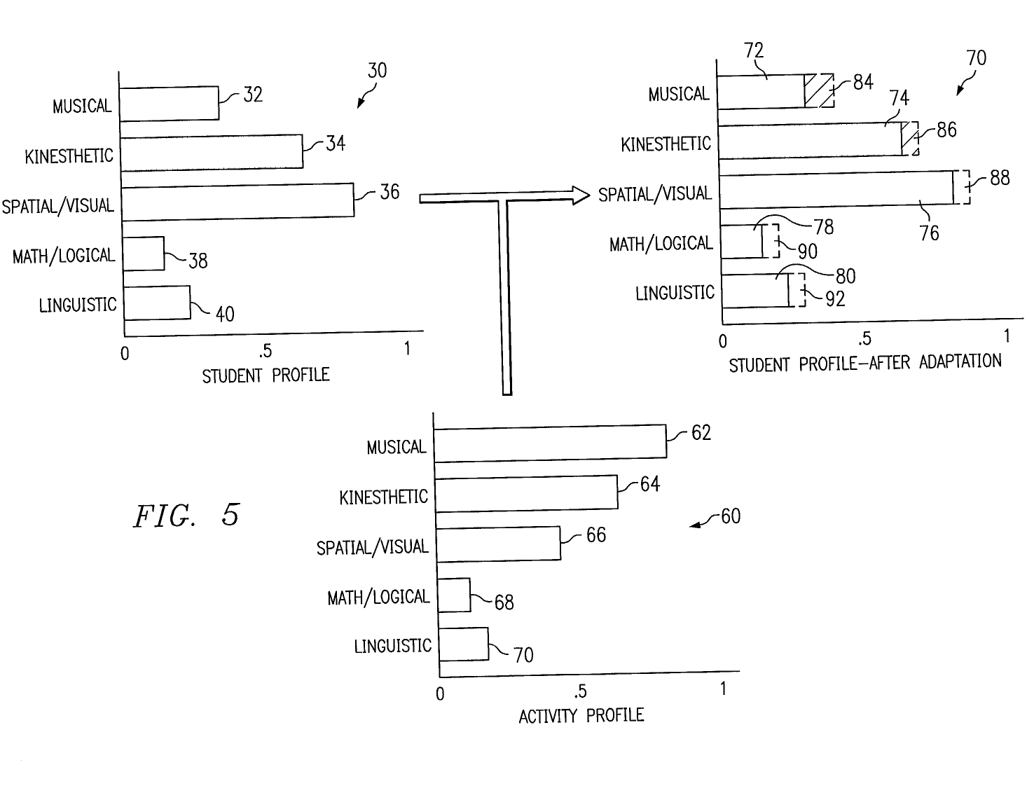

Diagram 60 of FIG. 5 includes the different modality proclivity measurements of the activity profile as shown in FIG. 4. As FIG. 5 illustrates combination of the student profile diagram 30 and media modality profile diagram 60 to yield combine student profile-after adaptation diagram 70 which shows, according to the different modalities, musical proclivity as indicated by bar 72, kinesthetic as indicated by bar 74, spatial/visual proclivity as indicated by bar 76 and math/logical proclivity as indicated by bar 78, finally with linguistic proclivity bar 80, the effect of combining the student profile of diagram 30 with the activity profile of diagram 60. As diagram 70 indicates, the combining of media modality profile 62 with musical proclivity bar 32 yields a greater indication of a musical proclivity by virtue of the shaded area 82 of musical learning modality proclivity bar 72. Likewise, combining kinesthetic proclivity bar 64 of diagram 60 with kinesthetic learning modality proclivity bar 34 of diagram 30 also yields a marginal increase 86 as indicated by the horizontal lines appearing in kinesthetic proclivity bar 74 of FIG. 5. Conversely, spatial/visual proclivity bar 36 of FIG. 30 in combination with spatial/visual proclivity bar 66 yields a reduction as shown by the dotted line area 88 of spatial/visual bar 76. In addition, a reduction in student learning modality for math/logical modality and linguistic modalities are shown by dotted line areas 90 and 92 of respective bars 78 and 80 in diagram 70.

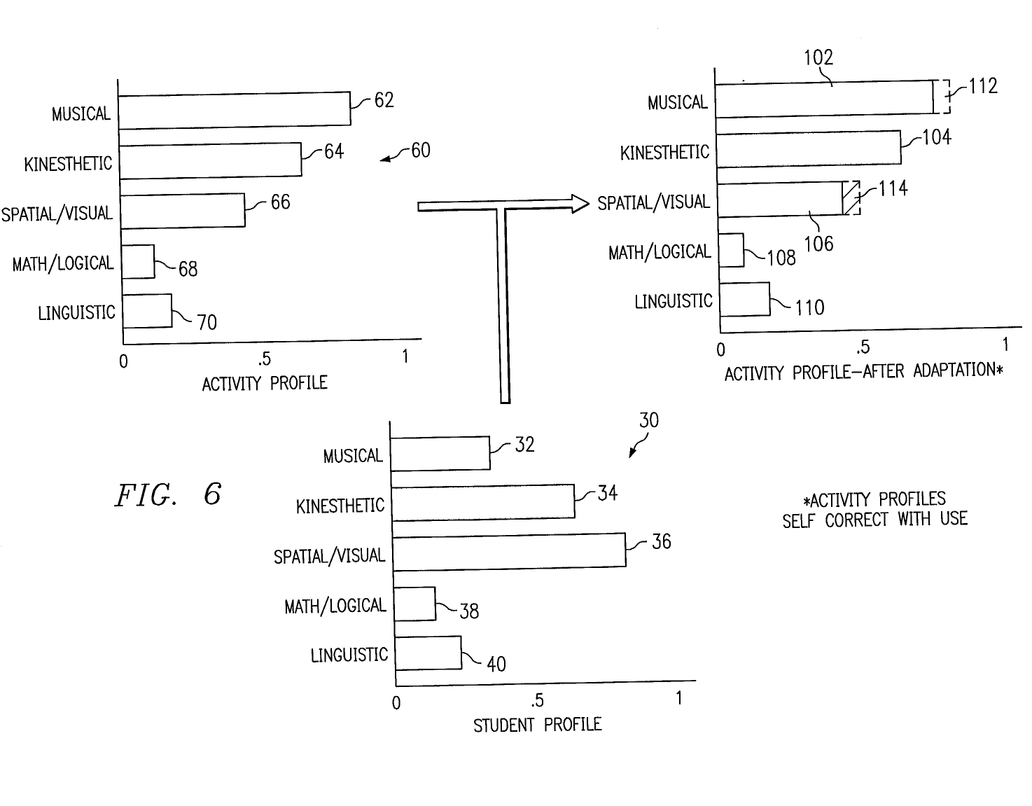

FIG. 6 illustrates the adaptation of media modality profiles in response to the adaptation that occurs through a given student or learner using the present invention. In particular, in diagram 60, including the different modality proclivity bars described in FIG. 4, when combined with the student profile diagram 30 as provided in FIG. 2, yields diagram 100 to indicate the activity profile after adaptation. In essence, the present invention provides for the self-correction activity profiles with use. As diagram 100 indicates, musical modality proclivity bar 102 results in a lessening of the musical modality proclivity as indicated by dotted line area 110 of bar 102. Conversely, spatial/visual proclivity bar 106 shows an increase in the spatial/visual modality proclivity as shown by diagonal box 112.

The present invention provides for the use of media modality profile tags to characterize a given media segment's affinity to a learner possessing a corresponding learning modality proclivity. Underlying assumptions for this aspect of the invention include the assumption that a media item will have a tag to represent a “learning score,” or how well a student with a given learning modality proclivity will learn from that media item.

The degree to which a student learns from a media segment is determined by both their engagement with the object and how the information is conveyed by that media segment. Engagement is to some extent a gatekeeper to further student examination of the media segment, thus playing a pivotal role. The degree to which media segment is engaging, or attention-getting, might also influence how memorable the media segment and, assumedly, the core meaning is remembered. General Guidelines relate to creating a media modality profile tag according to the present invention. One guideline is the criterion that when tagging a media item for a specific learning modality, the value for that learning modality is created with reference to how engaging that media item is to a person of that learning modality type. Another criterion is that the degree to which the information in that media item is conveyed through that modality For the MI in question, the media item is ranked from 1 to 5, 5 being the highest, for each of the above criteria. These criteria are used together to create the final media modality profile tag for the media item.

The “learning score” for an item is equivalent to the Engagement value as modified by the conveyance value. So, if the conveyance value is greater than, equal to, or 1 less than the engagement value, then the learning score is equal to the engagement value If, on the other hand, the magnitude of the difference between the conveyance and engagement value is 2 or 3, then the learning score is equal to the engagement value modified by 1, up or down, as appropriate. If the magnitude of the difference between the engagement and conveyance value is 4, then the learning value is 3 i.e., the midpoint between the two values.

There are specific media categories where generalizations are useful. For example, poetry will receive a linguistic engagement score of at least 4. Poetry with clever wordplay, such as poetry by Dr. Seuss, will receive a linguistic engagement score of 5. Non-spoken rhyming poetry may receive a musical engagement score of 2. Spoken rhyming poetry will receive a musical engagement score of 4. Non-rhyming/rhythmic poetry, such as T. S. Eliot, will not warrant a Musical engagement score, or receives a Musical engagement score of 1.

A video of only an interview or a “talking head” such as a news anchor delivering the news may receive a visual engagement score of 2. Video of movement or action may receive a visual engagement score of 4. Video with special effects, such as a music video having quick-cut editing may receive a visual engagement score of 5.

A video of only an interview or a “talking head” may also receives a Linguistic engagement score of 4.

Textbook text will be defined as straight, unflourished, text of multiple lines and/or paragraphs. Textbook text may receive a linguistic engagement score of 3. Full, rich narrative text, on the other hand, will receive a linguistic engagement score of 5.

Fully developed instrumental music without lyrics, such as jazz or classical music, will receive a musical engagement score of 5. Instrumental music designed as background music, rhythmic beats, or muzac may receive a musical engagement score of 3. Instrumental music synched with action or video such as video movement timed to the beat of the song, for instance, may receive a musical engagement score of 4.

Fully developed music with lyrics, such as a ballad or a rap, may receive a musical engagement score of 5. Rhythmic spoken word poetry may receive a musical engagement score of 4.Sung lyrics may receive a linguistic engagement score of 3. Speech over background music may receive a musical engagement score of 3, as background music. Speech over background music receives a linguistic engagement score of at least 4, possibly 5, depending on the quality and richness of the speech.

With regard to websites or Internet media, only the page the student is brought to is tagged. Connecting or linked pages are not tagged. The score is based on what page the student is brought to and not the potential to bring oneself to. By virtue of being a website, it automatically receives a Kinesthetic engagement value of 2 (see e.g.,) http://www.docuweb.ca/SiSpain/enalish/historv/discover.html) If the text is loaded with hyperlinks and hotlinks, it receives a kinesthetic engagement value of 4 (see e.g.,) http://www.vaca.corn/insetl l.html). If the website allows a student to create or start a limited action along a predetermined path that reinforces the content being learned (e.g.,) if a student clicks a button and it shows Columbus's ship sail from Point A to Point B, it receives a Kinesthetic conveyance score of 3. If the website allows a student interactive free reign that reinforces the content being learned (e.g.,), if a student is allowed to sail Columbus's ship from Point A to Point B and is also allowed the sail the ship helter-skelter, it receives a kinesthetic conveyance score of 5. This condition implies some kind of interactive Flash, Shockwave, and/or Applet activity.

The present invention employs learning modality proclivity profiles to characterize how a learner best accomplishes the individual process of learning. For example, learners may be kinesthetic, linguistic, logical/mathematical, visual/spatial, musical, interpersonal, intrapersonal, or naturalist in their learning modality proclivities. The present invention assists learners with different learning proclivities to learn ther best using the ways in which they best process information and master new concepts. The following discussion details more particularly the learning modality proclivities that different learners exhibit.

A student with a high kinesthetic strength might enjoy playing sports and other physical activities. He or she might have a keen ability to read body language or mimic the behavior of others. He or she might like taking things apart and building things, have good gross and fine motor skills, and be attuned to physical or tactile sensations. The learner with a high kinesthetic learning modality proclivity profile has the ability to think in movements and to use the body in skilled and complicated ways for expressive and goal-directed activities.

Such a learner possesses a sense of timing, coordination for whole body movement and the use of hands for manipulating objects.

A student with a high linguistic strength might enjoy hearing and telling stories, playing word games, and writing rhymes and poetry. He or she might have a good memory for words and prefer communicating information through text or speech. The learner with a high linguistic learning modality proclivity profile has the ability to think in words and to use language to express and understand complex meanings. Such a learner possesses a sensitivity to the meaning of words and the order among words, sounds, rhythms, inflections. To reflect the use of language in everyday life.

A student with a high logical/mathematical strength might enjoy working with numbers, playing strategy games and brainteasers, figuring out how things work, categorizing things, and conducting experiments. The learner with a high logical/mathematical learning modality proclivity profile has proclivity to think of cause and effect connections and to understand relationships among actions, objects or ideas. Such a learner possesses an ability to calculate, quantify, or consider propositions and perform complex mathematical or logical operations. It involves inductive and deductive reasoning skills as well as critical and creative problem-solving.”

A student with a high visual/spatial strength might enjoy viewing and working with maps, diagrams and pictures, watching video and animation, and communicating information graphically. The learner with a high visual/spatial learning modality proclivity profile has the ability to think in pictures and to perceive the visual world accurately. Such a learner possesses the proclivity to think in 3-D and to transform one's perceptions and recreate aspects of one's visual experience via imagination. To work with objects effectively.

A student with a high musical strength might enjoy listening to, playing, and writing songs and melodies. He or she might be good at detecting music that is out of key, and be able to identify an event or object based on its sound. He or she might have a good memory for tunes and be able to identify rhythms and patterns. The learner with a high musical learning modality proclivity profile has the ability to think in sounds, rhythms, melodies and rhymes. Such a learner possesses a proclivity to be sensitive to pitch, rhythm, timbre and tone. To recognize, create and reproduce music by using an instrument or voice. Active listening and a strong connection between music and emotions.

The learner with a high interpersonal learning modality proclivity profile has the ability to perceive and make distinctions in the moods, intentions, motivations, and feelings of other people. This can include sensitivity to facial expressions, voices, and gestures; the capacity for discriminating among many different kinds of interpersonal cues. Such a learner possesses the ability to respond effectively to those cues; and the ability to respond effectively to those cues in some pragmatic way (e.g., to influence a group of people to follow a certain line of action.) Such a learner shows the ability to think about and understand another person. To have empathy and recognize distinctions among people and to appreciate their perspectives with a sensitivity to their motives, moods and intentions. It involves interacting effectively with one or more people among family, friends or working relationships.

A learner with a high intrapersonal learning modality proclivity profile has a keen self-knowledge and the ability to act adaptively on the basis of that knowledge. This intelligence includes having and accurate picture of oneself (one's strengths and limitations); awareness of inner moods, intentions, motivations, temperaments, and desires; and the capacity for self-discipline, self-understanding, and self-esteem. Such a learner possesses the ability to think about and understand one's self; to be aware of one's strengths and weaknesses and to plan effectively to achieve personal goals. This involves reflecting on and monitoring one's thoughts and feelings and regulating them effectively. The ability to monitor one's self in interpersonal relationships and to act with personal efficacy.

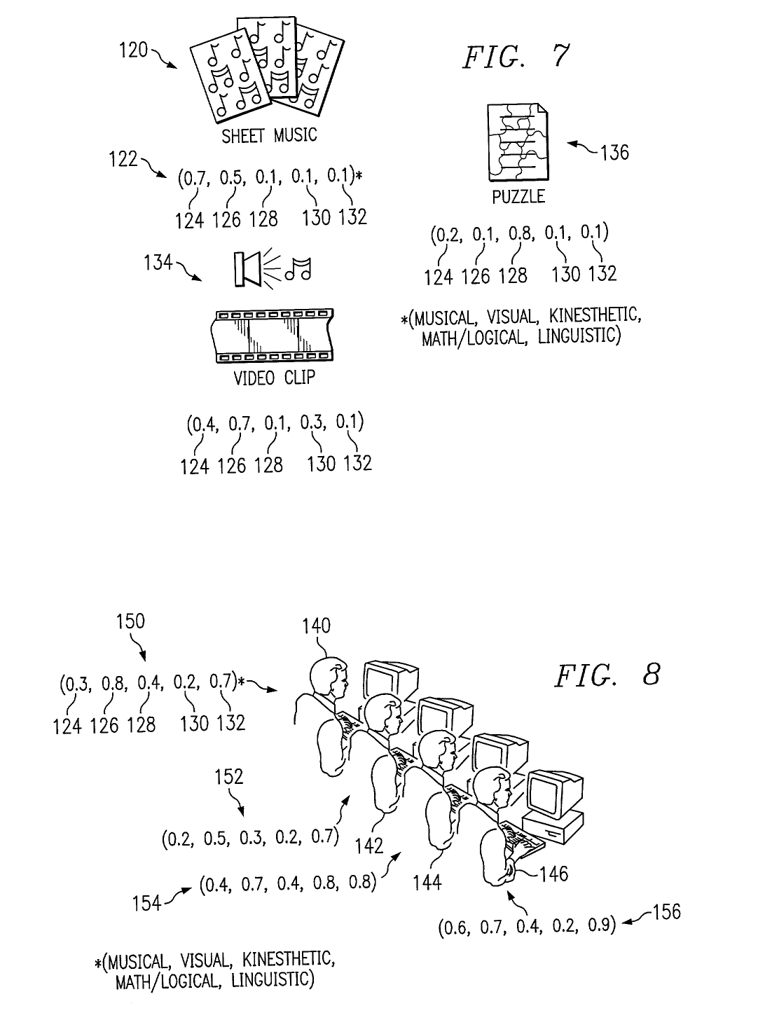

FIGS. 7 and 8 detect the different modality ratings that a particular type of media may possess and a particular type of user may possess, for example. In FIG. 7, written music piece 120 when associated modality vector for which the elements in the vector indicate the normalized modality proclivity of a particular type of media. For example, written music 120 shows in vector 122 in position 124 a rating of 0.7 on a 0.0-1.0 scale indicating a high musical proclivity. In position 126, visual modality proclivity measured 01.5 indicates some measure of the visual modality but less than that of the musical modality proclivity as indicated by the 0.7 value at position 124. As position 128, position 130 and position 132 appear slight, but close to 0, values for the respective modalities, kinesthetic, math/logical and linguistic. On the other hand, the cinema and soundtrack media as represented by icon 134 shows a value of 0.4 for the musical modality, but with a higher value of 0.7 for the visual modality proclivity at position 126. Higher is the value of 0.3 at position 130, whereas positions 128 and 132 show the lower value of 0.1 for the kinesthetic and linguistic proclivities at positions 128 and 132. Finally, textural media 136 shows the highest modality proclivity value of 0.8 at position 128 indicating a high kinesthetic proclivity, whereas the values for the visual, math/logical and linguistic proclivities take a value of 0.1 as indicated by their respective values at positions 126, 130 and 132. However, only a slight increase appears with regard to the musical proclivity having the value of 0.2.

FIG. 8 shows that individual learners as indicated by individuals 140, 142, 144 and 146 have potentially unique user profiles indicating their respective learning modality proclivities. In particular, individual 140 appears by virtue of the user profile vector 150 to have a greater visual modality proclivity by the factor of 0.8 occupying space 126 in vector 150. In addition the value of 0.7 at the linguistic position 132 indicates a high propensity for the linguistic modality also. Not so high however, are the values for kinesthetic (0.4), math/logical (0.2), and musical (0.3) at respective positions 128, 130 and 124. Vectors 152 for learner 142, 154 for learner 144, and vector 156 for learner 146 further indicate the different values for the different modality proclivities can be highly descriptive of the best learning modality for the individual.

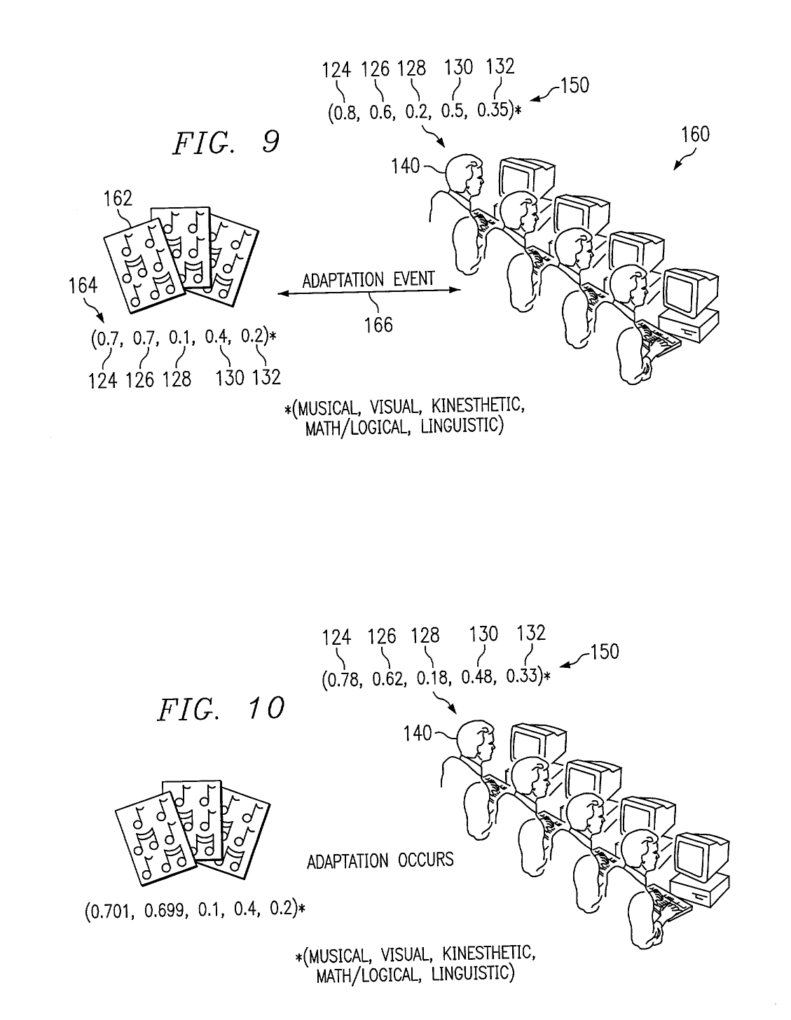

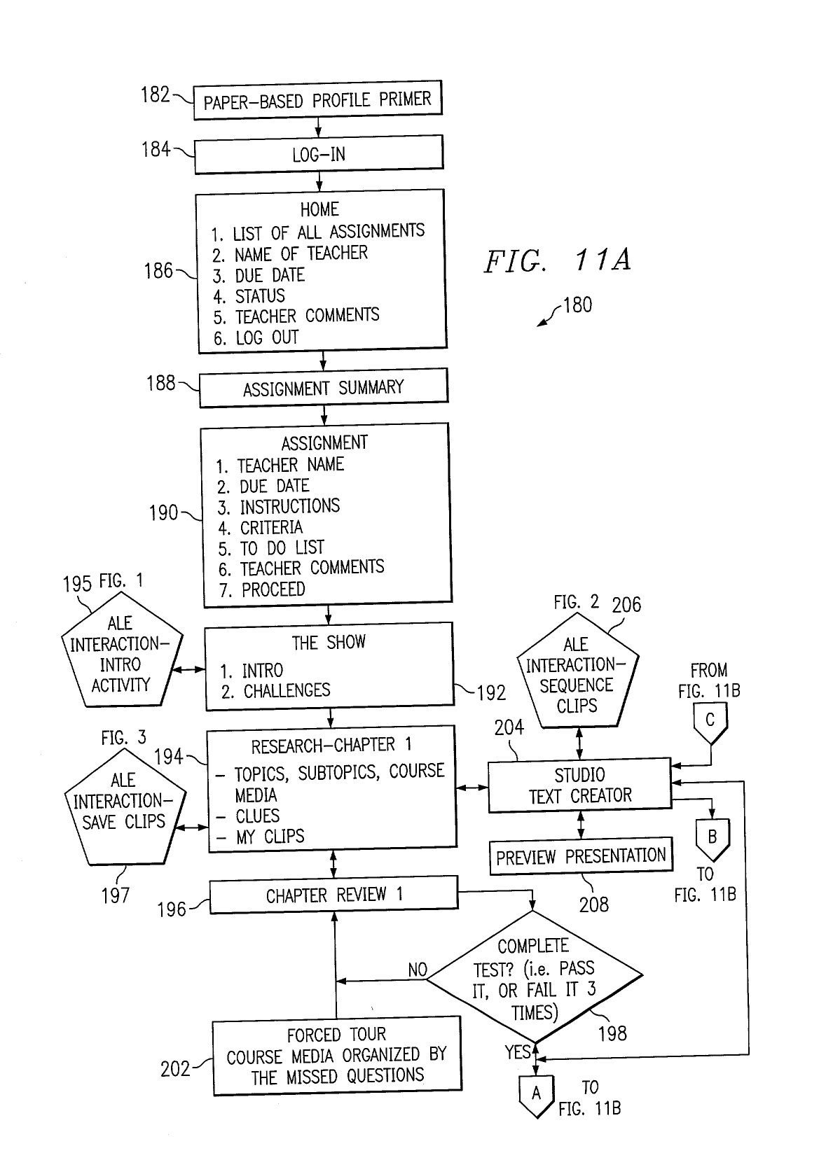

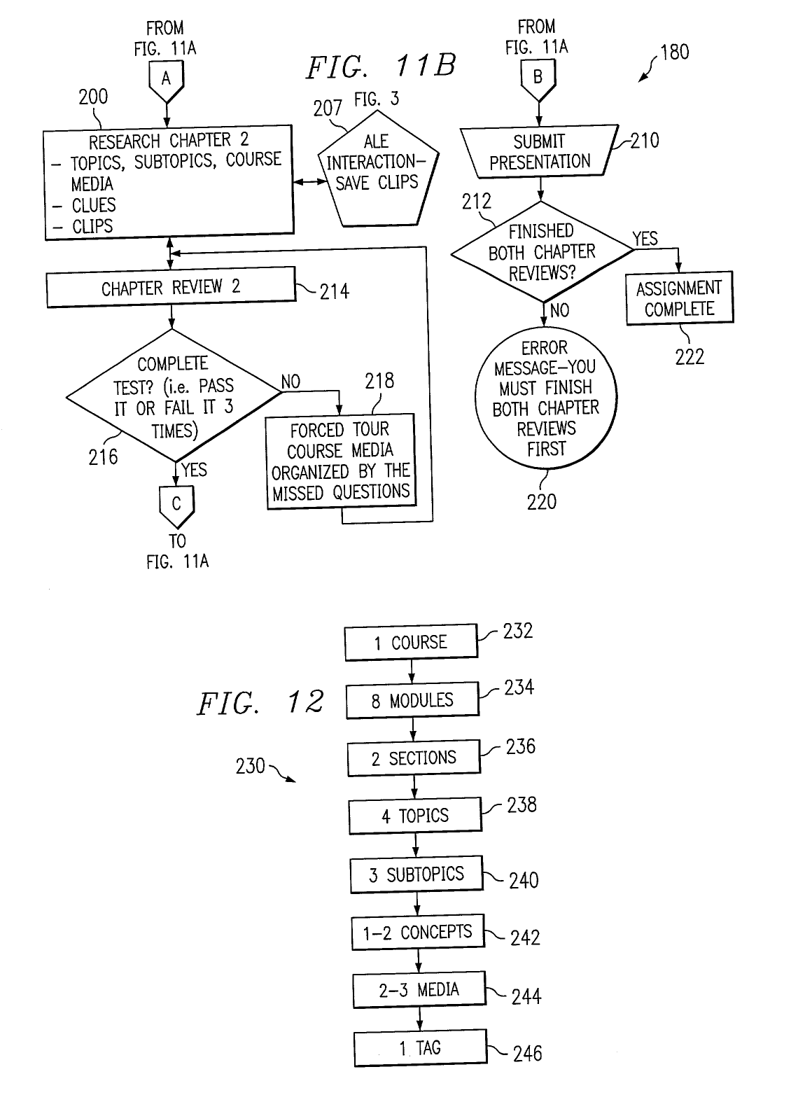

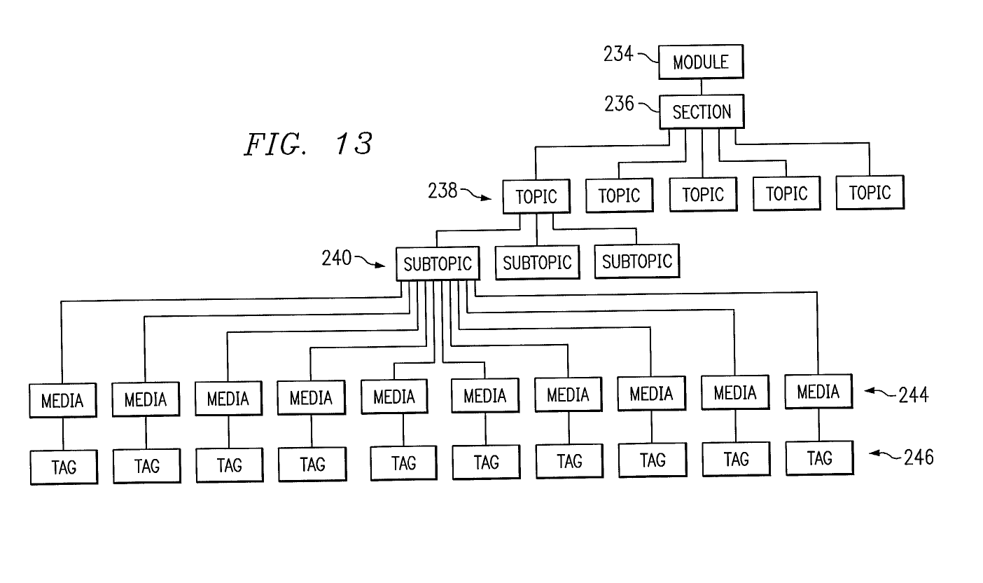

FIGS. 9 and 10 further illustrate the concept first described in FIGS. 5 and 6 to show how the adaptation results in modification not only for the user but also for the media profile. In particular, given process 160 there appears music media 162 having associated modality vector 164 having the values of (0.7, 0.7, 0.1, 0.4, 0.2) showing the different values at the respective vector positions for the different modalities described above in connection with FIGS. 7 and 8. Adaptation event 166 learner 140 applies the modality proclivity vector 150 to result in an adaptation as indicated in FIG. 10. FIG. 10 shows that after the process described in actions in connection with FIGS. 7 and 8, music media 162 assumes a revised vector 170 that shows different values for the different modality proclivity measures in the modality vector. For example, on the adaptation of the 0.7 value at position 124 of vector 64 with the 0.8 value at position 124 of vector 150, the resulting value of 0.701 at vector 170 for the musical modality of position 124 indicates a slight increase by virtue of the highly musically FIG. 10 further illustrates the modification for the user profile for learner 140 that occurs by the change in vector 150. For example, because of the use by learner 140 having at position 124 the modality proclivity measure of 0.8 for the musical modality, his choosing of a media 162 having at position 124 the proclivity measurement of 0.7 results in the reduction of the proclivity value from 0.8 as shown in FIG. 9 to the new value at position 124 of 0.78. Other modifications to the vector 150 in FIG. 10 reflect the adaptation occurring by the selection of media 162 by learner 140.

To put the notion of “interesting to a given student” into mathematical terms, the present invention defines a relation between the learner's learning modality proclivity profile and a tag indicating the profile media modality of a media clip. This relation is not symmetric, because the present invention uses the relative rankings of the student's MI profile to bias the relation in the same way that the student's interests are biased. For example, when choosing a media clip for a student who is strongly linguistic but only marginally musical, the present invention deals more directly with how linguistic the media is than with how musical it is.

The present invention mathematically determines how interesting a given media piece will be to a student using a “least sum of differences” method. That is, the present invention examines each intelligence in the two profiles and keeps a running total of the difference between each pair. The media clip that has the lowest total difference is defined to be the most similar to the student's profile.

The above biasing process is implemented using a filter vector with entries between 0 and 1 whose values are computed from the ranking of the student's profile. That is, for a student whose highest score is mathematical, the entry in the filter vector for that slot would be 1. The entry for the next highest score would be perhaps 0.5, and so on down the list of intelligences. Then, instead of using the raw differences between the student's scores and a media segment's scores, each difference is multiplied by the corresponding entry in the filter vector before being added to the running total. This has the effect of making differences in the student's best abilities affect the total more than differences in abilities where the student is weak or uninterested. A student or a non-student profile may be initialized with a “null” profile. The null profile is a vector in which all 5 elements have the value 0.5

The adaptation formula of the present invention “adapts” or moves a selected profile toward another profile. The equation is used first to adapt the student's profile, and then again, to adapt the packet's profile. c˜j=c˜j+h(caj−c˜j) forallI where: h=a/(1+pk), 0<h<1c˜′=the i^{th} component of the target vector (vector being adapted) C ai=the iₜₕ component of the vector the target vector is adapting to a=a number between 0 and 1 that reflects “how much” the adapting vector should influence the target vector p=the number of times the target vector has encountered the adapting item before k=a number greater 2 0 than describes the target vector's resistance to change

The present invention addresses two issues relating to the initial assessment of the Adaptive Learning Engine (ALE) these include placement and use of the filtering vector in the calculation of the Closest Fit and elaboration upon the use of the constants within in the adaptation formula. These formulas are used within the adaptive learning assessments determining learning modality proclivity profiles and media modality profile tags as applied with the present invention.

The present invention uses a Closest Fit function to identify the one media item or object out of a collection of items that has a profile most similar or “closest” to a specific learner's learning modality proclivity profile. This function minimizes the sum of the absolute values of the differences between each component of a student profile (target vector) and a set of candidate media items (candidate vectors). This function, is as follows:

Closest=min ((Σ|cₜᵢ−cⱼᵢ| for all i)/n) for all j

where:

cₜᵢ=the i^{th} component of the target vector

cⱼᵢ=the i^{th} component of the j^{th} candidate vector

n=the number of components of each vector

The adaptive learning engine of the present invention includes a filtering function that may be used in the closest fit calculation. Because of the problem of equivalent “fits” that arises as the number of attributes in the vector increases, this is useful.

In the following example (see attached diagram), media items #1 and #2 have numerically equivalent “fits” to a student profile, and yet are significantly different from a qualitative perspective. Media items #1 and #2 are the same when judged on the basis of the student's top two learning strengths. Media item #2 is closer when judged on the top three learning strengths.

There are two problems that occur as the number of attributes increases. The greater the number of attributes, the more dimensions and therefore “ways” to obtain the same numerical fit. We begin by assuming that the top two or three learning strengths are most important in determining the effectiveness of a media item. Increasing the number of attributes used in the calculation of closest fit increases the noise-to-signal ratio, lessening the ability of the function to discriminate effectively between different media items.

Implementation of a filtering function in the adaptive learning engine enhances the ability of the “closest fit” function to select a media item that truly enhances the student's learning.

The filtering function will be implemented in the adaptive learning engine as Filtered Closest=min ((aᵢ|cₜᵢ−cⱼᵢ for all i)/Σaᵢ) for all j where: 0≦aᵢ≦1 for i=1, 2, . . . , n aᵢ=the i component of the filtering vector

The filtering vector is preferably used in one of the following two ways. A first schema is one in which the closest fit is based on the student's top two learning strengths. In this schema, aᵢ=1 for the attributes associated with the student's top two learning strengths, and aᵢ=0 for all remaining attributes. In the other scheme, the closest fit is based on the student's top three learning strengths. In this schema, aᵢ=1 for the attributes associated with the student's top two learning strengths, and aᵢ=0.5 for the attribute associated with the student's third greatest learning strength. Also, aᵢ=0 for all remaining attributes

If it is certain that the exact same filtering schema will always be used, then the schema may be hard-coded into the adaptive learning engine software and the filtering vector may be calculated within the adaptive learning engine once it receives a learning modality proclivity profile. Otherwise, the filtering vector may be calculated in the calling program and passed as a vector of numbers to the adaptive learning engine along with the student's profile.

This adaptation function of the present invention “adapts” or moves a selected profile toward another profile and is shown in the following text box. cₜᵢ=cₜᵢ+h (cₐᵢ−cₜᵢ) for all i where: h=a/(1+pk), 0≦h≦1cₜᵢ=the i^{th} component of the target vector (vector being adapted) cₐᵢ=the i^{th} component of the vector the target vector is adapting to a=a number between 0 and 1 that reflects “how much” the adapting vector should influence the target vector p=the number of times the target vector has encountered the adapting item before k=a number greater≧0 than describes the target vector's resistance to change In bi-directional adaptation the equation is used first to adapt the student's profile, and then again, to adapt a packet profile. The constants in this equation, namely “a”, “p” and “k” may be included in the instructions for implementing the adaptation function.

A characteristic of sequential, bi-directional adaptation is that the order of adaptation affects the value of the outcomes. In other words, if, for example, the learner modality proclivity profile adapts a puzzle modality profile tag and then the puzzle modality profile tag adapts the learner modality proclivity profile the answer is most likely different than if the puzzle first adapts the learner modality proclivity profile and then the learner modality proclivity profile adapts the puzzle modality profile tag. From a practical standpoint, the consequences of this characteristic are most important when one or both profiles are immature (e.g., the profiles have recently been initialized and have a low resistance to change).

From the above equation, there are likely to be two sets of adaptation constants in every bi-directional adaptation. Assuming that the learning proclivity profile modality is adapted first, the target profile is the student's profile. In this case. The constant “a” reflects how much the adapting profile for either a puzzle, media item, immersive activity, should influence the learner's learning modality proclivity profile. This is a property of the adapting item and not of the student. The value of this constant may be thought of as a measure of reliability or validity for the adapting item. For example, carefully constructed puzzles may have a higher “a” value than might media items, since the selection of a media item is confounded with the content quality of that item and not just the learner's modality proclivity.

It is an educational design issue to determine what characteristics of the adapting item, such as validity and reliability, will be manifested in the constant “a,” and what function is used to describe the change in the constant “a.”

The constant “k” describes the target learning modality proclivity profiles resistance to change. This constant is associated with the learner's profile and may reflect the system's confidence in its current value. For example, if the learner's has limited interaction with the system, such as when initiating a new subject profile for the learner, then the confidence in the learner's profile may be “low” and, therefore, the resistance to change would be low. As the learner continues to interact with the system over multiple modules, the system's confidence in the learner's profile may be “high” and, therefore, its resistance to change would be high.

The criteria related to “resistance to change,” such as consistency of learner choice or variation in the learner profile, will be manifested in the constant “k,” and as will what function is used to describe the change in the constant The constant “p is the number of times a learning modality proclivity profile has encountered the adapting item before.”

The constant “p” is a property of both the learner and the adapting media item. For example, if the learner has already taken a puzzle before, p is incremented by the value one. Increasing the value of p increases the learner profile's resistance to change.

In the use of the present invention it is possible to determine what is being counted by the variable “p.” For example, “p” may count the number of times a specific puzzle has been encountered by a learner. “p” may count the number of times the learner has previously encountered puzzles of this type. Also, the user of the present invention ma determine the specific criteria for incrementing the counter.

In the second half of bi-directional adaptation, the learning modality proclivity profile becomes the adapting vector for a media modality profile tag.

The constant “a” reflects how much the learner's profile should influence the target vector. This is a property of the learner. The value of this constant could be made a measure of the system's confidence in the current value of the learner's profile and, therefore, may be related to the constant “k” in a previous adaptation round.

Also, in the second half of the bi-directional adaptation, the constant “k” describes the target vector's resistance to change by the learner vector. This constant is associated with the target vector and may reflect the system's confidence in the target vector's current value. For example, if thousands of learners have adapted the puzzle through use, then the puzzle would likely be highly resistant to change by the next learner it encounters.

The present invention permits the user to determine what criteria is related to “resistance to change,” such as number of learners that have adapted the puzzle through use, and what function is used to describe the change in the constant “k.”

Also, in the second half of the bi-directional adaptation, the constant “p” is the number of times the target (puzzle) vector has encountered a specific learner item. The constant “p” is a property of both the learner and the adapting item. For example, if the learner has already taken this puzzle before, p is incremented by the value one. Increasing the value of p increases the target profile's resistance to change. In practice, this parameter may be meaningless. The number of times a target encounters any one child is insignificant relative to the hundreds of learners it is likely to encounter in a short period of time. At first approximation, this parameter can likely be set as p=1.0 for all non-learner target vectors.

The present invention also provides for for initializing media profiles. Moreover, functions of the present invention for “a” and “k” take into account the capability and reliability of the activities they are associated with. Still further, the present invention provides a closest-fit filtering vector has been created and implemented for the individualized presentation of media.

FIG. 11 shows diagram 180 that illustrates the learner interaction process of the present invention. Beginning at paper-base profile primer 182, the process proceeds when the learner logs on as indicated by block 184. From the login screen, the learner is then taken to the Home Page wherein he has access to a list of assignments, the name of the teacher for the respective assignment, and the due date for the particular assignments. Additionally, the Home Page would provide, for example, the status of a particular project, any teacher comments relating to learner or project, as well as a logout function that permits the exiting of the system.

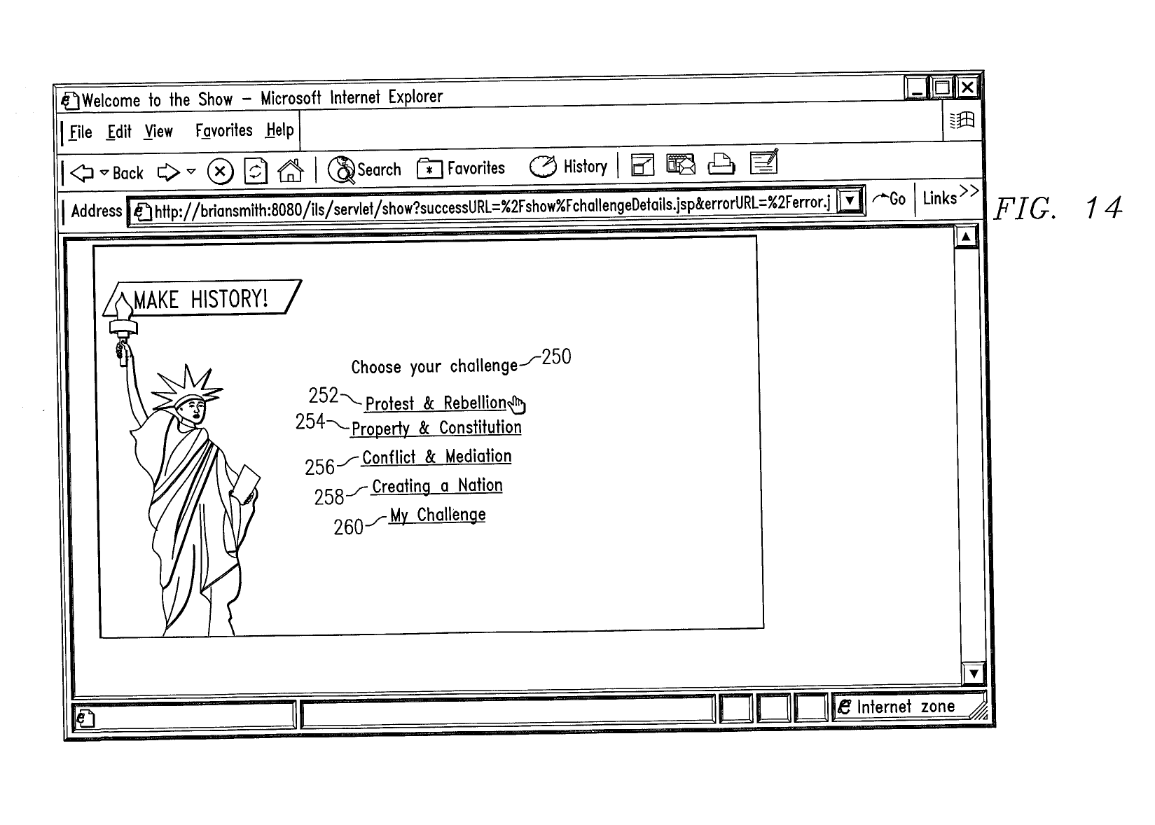

From the Home Page to the learner may next address the assignment summary, as indicated by block 188. The assignment summary then permits the access to the assignment module as indicated in block 190. The assignment indicates the teacher name, due date, and relevant instructions relating to particular assignment. Moreover, information relating to certain assignment criteria or any To Do lists relating to the particular assignment will also be provided. Teacher comments may further be included in the stage of this process, as well as the direction or query to the learner as to how to proceed. Upon the determination to proceed, process flow goes to block 192, which begins with the Show and provides some introduction to the process as would be seen in FIG. 12 below. Moreover, the particular Show would include challenges that would be proposed to the learner for the purpose of inviting the learner to respond to the challenges of constructing a particular work report or other desired result.

The present invention at this point in time, as indicated by hexagon 194, begins the process of determining or using the adaptive learning engine to determine the learning modality proclivities of the learner and to begin assessing the appropriate material. The affects the order of presenting by making it consistent with the learning modality proclivity of the learner. The process then proceeds to step 194. At step 194, for example, a first chapter will begin that involves research. This will include research of topics, subtopics and the relevant course media that the learner may access. In addition, clues can be provided to the learner that can suggest the use of particular media. Moreover, the learner will then have the ability to take from the course media and material information to create the “My Clips” repository of information that the learner will use for developing his report or thesis in accomplishing his desired result.

As indicated by block 196, the alternative learning engine also assesses, at this point, the learning modality proclivity of the learner by assessing the modalities of the saved clips (i.e., those clips that were saved by the learner in the “My Clips” repository). After completing Chapter 1 research block 194, the process of the present invention continues at block 196 for a review of Chapter 1 to determine whether or not, as block 198 indicates, the learner has completed the test of necessary information as a result of obtaining the information for the challenge to which the learner is responding. In the event that the learner passes, process flow proceeds to block 200 which will be described below. In the event, on the other hand, that the use fails to complete the test or fails to respond successfully to the queries or examination that occurs at block 198, then process flow proceeds to block 202. At block 202, the learner is presented with a forced tour or guided tour where course media is organized according the question or questions that have been missed by the learner in the examination occurring in block 198.

After the forced tour of block 202, the Chapter 1 review again proceeds to step 196 for continuing review. Thereafter, examination occurs at step 198. Step 198 again examines whether the learner has passed or has failed to pass the examination three (3) times. If the learner has failed three times, the process continues onto Chapter 2 with an early report going to the teacher indicating that there is still learning for the learner to achieve. The learner may exit the chapter review either process flow to continue to block 200 for researching Chapter 2 or process review may be exited. Then the learner may enter the research Chapter 1 block 194 to the studio text creator at block 204. The studio text creator 201 provides a platform for the learner to assemble and use the information that it has assembled and stored in the “My Clips” media. Again, as hexagon 206 indicates, the adaptive learning agent will assess both the learner and the media. Block 208 indicates the ability of the learner to preview the presentation in preparation for moving onto the next lesson.

In the studio text creator, block 204, process flow continues to step 210 wherein the learner may submit the presentation. Thereafter, process flow proceeds to step or query 212, at which the test has made to whether the learner has finished both chapter reviews. At the studio text creator, process flow communicates with Research Chapter 2 block 200, as previously mentioned. Moreover, at chapter 2 review block 214, as was the case with regard to Chapter review 1 block 214, chapter review occurs. A test is made at block 216. Then, as was done Chapter 1, the present invention provides a forced tour at 218 in the event that the learner fails to complete the test or has failed the test three times. Once the forced tour is complete, the process flow returns to Chapter 2 review block 214. As block 216 indicates, in the event that the learner passes the Chapter 2 review or has failed it three times, process flow then communicates with studio text creator 204 for the continuing flow of the process through to submit presentation step 210.

As previously mentioned, when both Chapter 1 and 2 reviews are complete the process flow moves to completion. This test is determined at block 212. In the event that not both chapter reviews are complete, block 220 returns an error message to the learner stating that the learner must finish both chapter reviews before being credited with completing the assignments. If, as tested at query 212, both chapter reviews have been completed. Process continues to block 222, where the assignment is determined to be complete and process flow returns to home page 186 for completion of the or the beginning of the assignment showing the progress of the learner to the teacher. Moreover, at the Home Page, teacher comments are provided and the process of reviewing chapters 1 and 2, for example.

FIG. 12 illustrates the hierarchal diagram 230 showing how a course 232 of the present invention may be organized, first, a course may have a number of modules, for example, eight modules, as block 234 indicates. Each of the eight modules may be further divided into sections, which in the diagram 230 appear as block 236 of two sections. Topics within each Section can be provided, as block 238 indicates, into four topics. Each of the topics may then be broken down into subtopics, as block 240 indicates, within each subtopic there may be one or two concepts to be presented, as block 242 indicates. With the present invention, the particular subtopics may be demonstrated by two or three media, as block 244 indicates. Moreover, in particular relevant to the present invention, is how at 246 there is assigned a media modality profile tag indicating the modality vector, such as vector 150 appearing in FIG. 4.

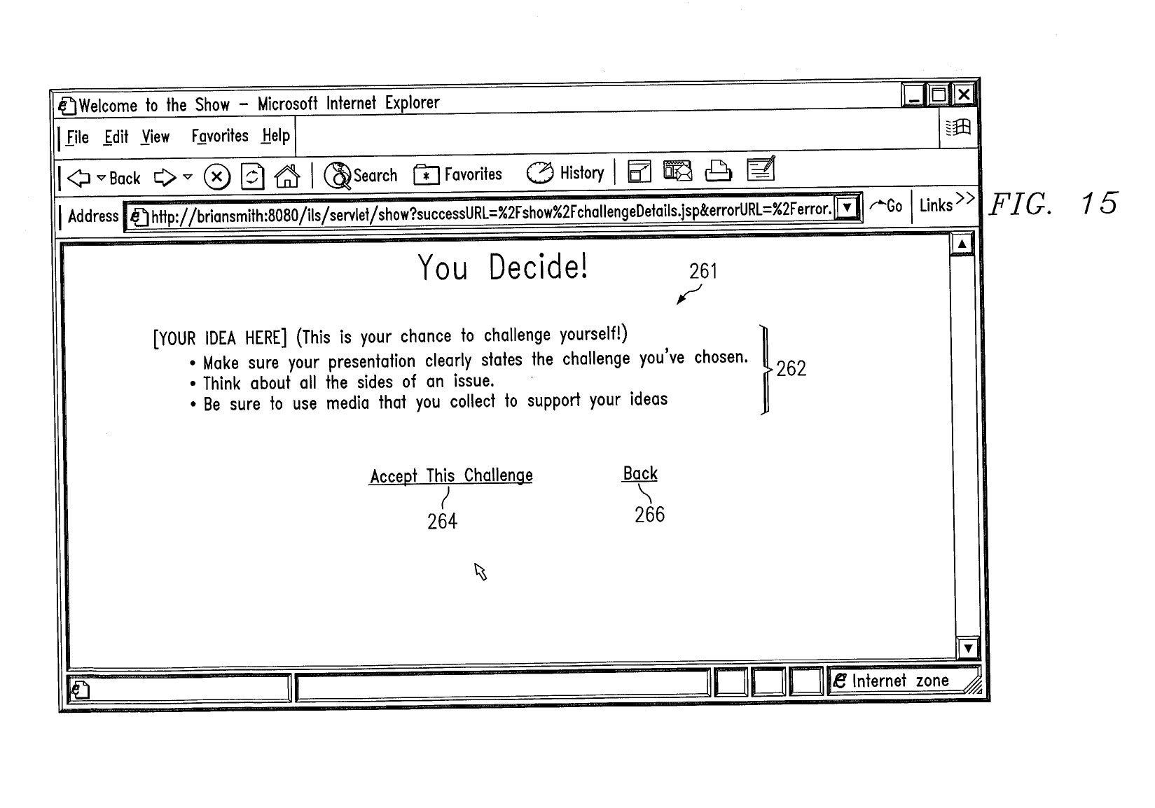

FIG. 13 further illustrates the hierarchical organization of the content that the present invention provides, as well as the how the present invention uses media modality profile tags for identifying the learning modality of each particular media. In particular, as FIG. 3 illustrates, a module 234 may have at least one section 236. Within each section will be a number of topics 238. For example, that topic may include a number of subtopics 240. Each subtopic 240 may include a number of different types media 244 for which each media will have, in accordance with the present invention, a tag indicating the particular learning modality.

This permits working with the particular media according to the modality proclivity of the learner as well as the adaptation of the tag.

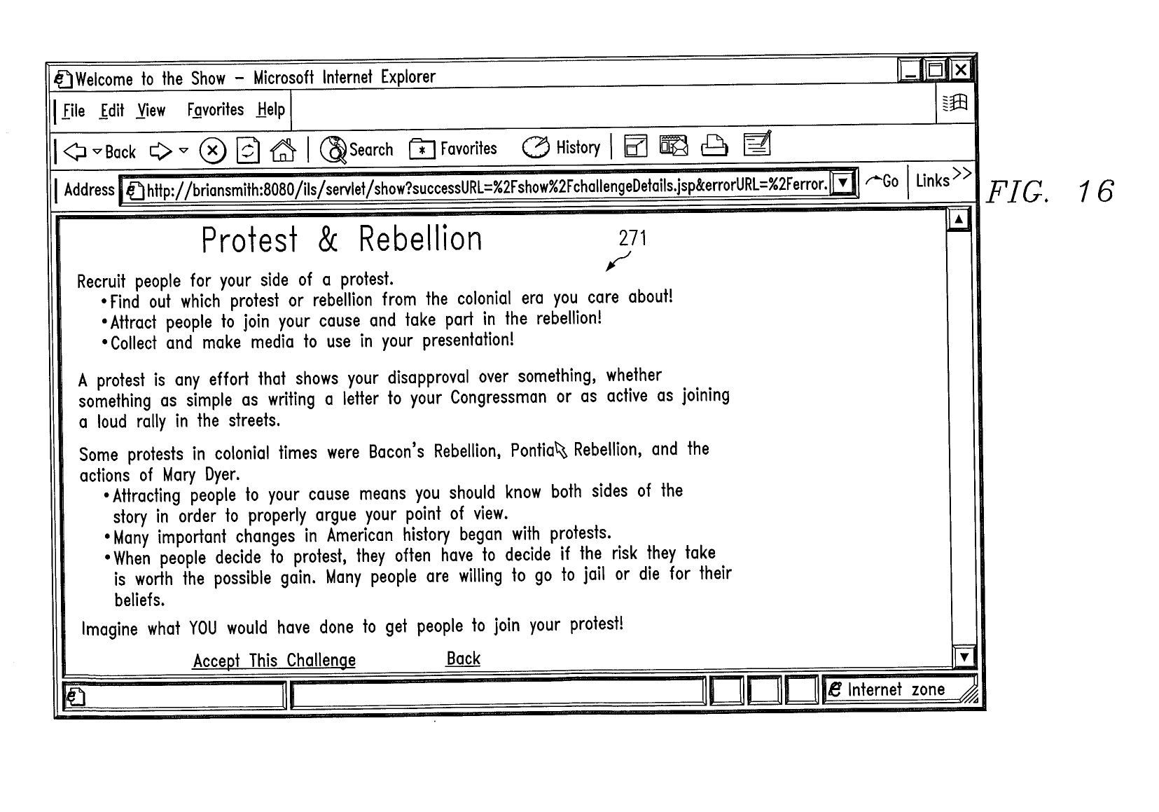

FIG. 14 illustrates one screen that may demonstrate the challenge that occurs at block 192 at FIG. 11. In particular, as FIG. 14 illustrates, line 250 directs the learner to choose a challenge. This challenge may be any nature to, for example, as line 252 Protest and Rebellion indicating that supporting Protest and Rebellion may be one of the challenges that a learner may address. Other challenges, as line 254 Property and Constitution illustrates, and further, as line 256 Conflict and Mediation illustrates may be available to the learner. Finally, in this example, line 258 Creating a Nation shows the optional challenges of the Creating a Nation line 260 You consider, further illustrates the challenge of the learner correcting his own challenge.

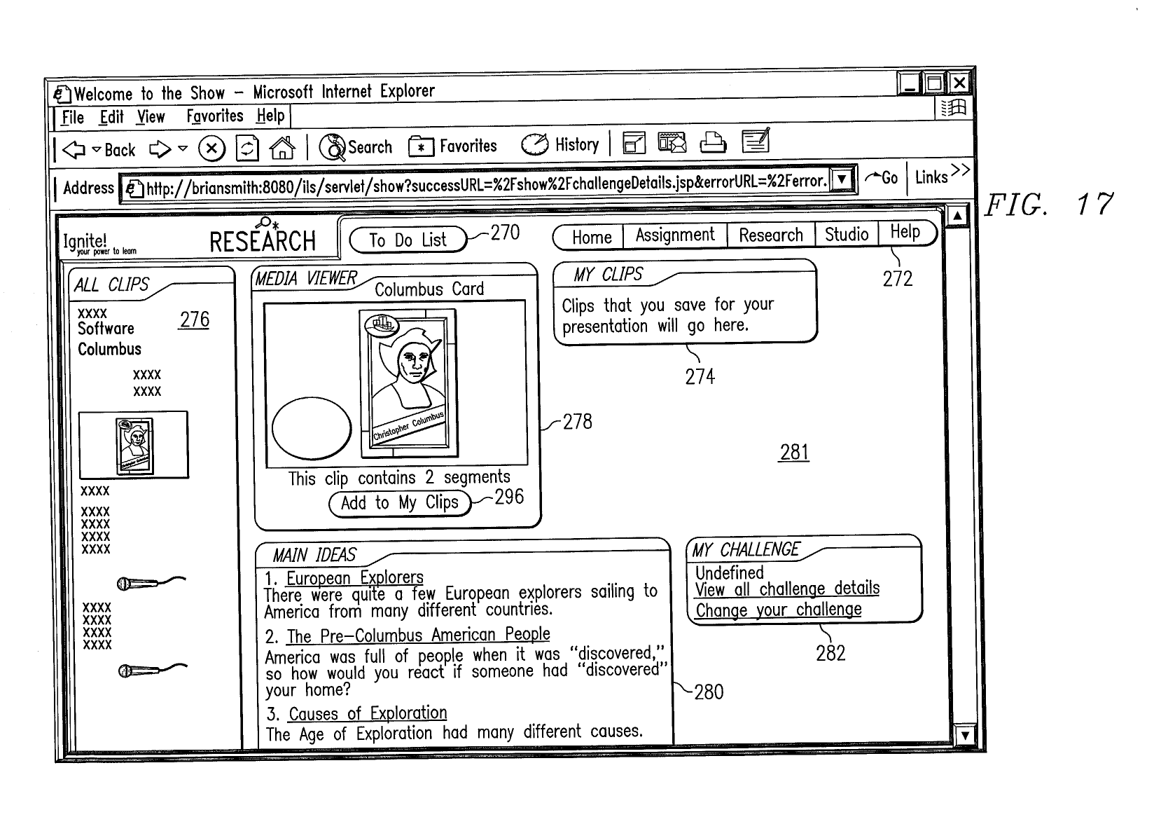

FIG. 15 illustrates the You Decide screen 201 that a learner may view invites the learner to place his idea in the screen, thus providing the learner a chance to challenge himself. As the text 262 shows, the learner is then directed to make sure the presentation clearly states that the challenge that he has chosen, as well as to think about all of the sides of the particular issues. The presentation further admonishes the learner to be sure to use media that you collect supports his idea. The idea being further that the media collected should be used in the presentation for this particular challenge. Button 264 provides a place where the learner can accept the challenge or 264 provides a button whereby the learner return back to the Choose Your Challenge screen of FIG. 14.

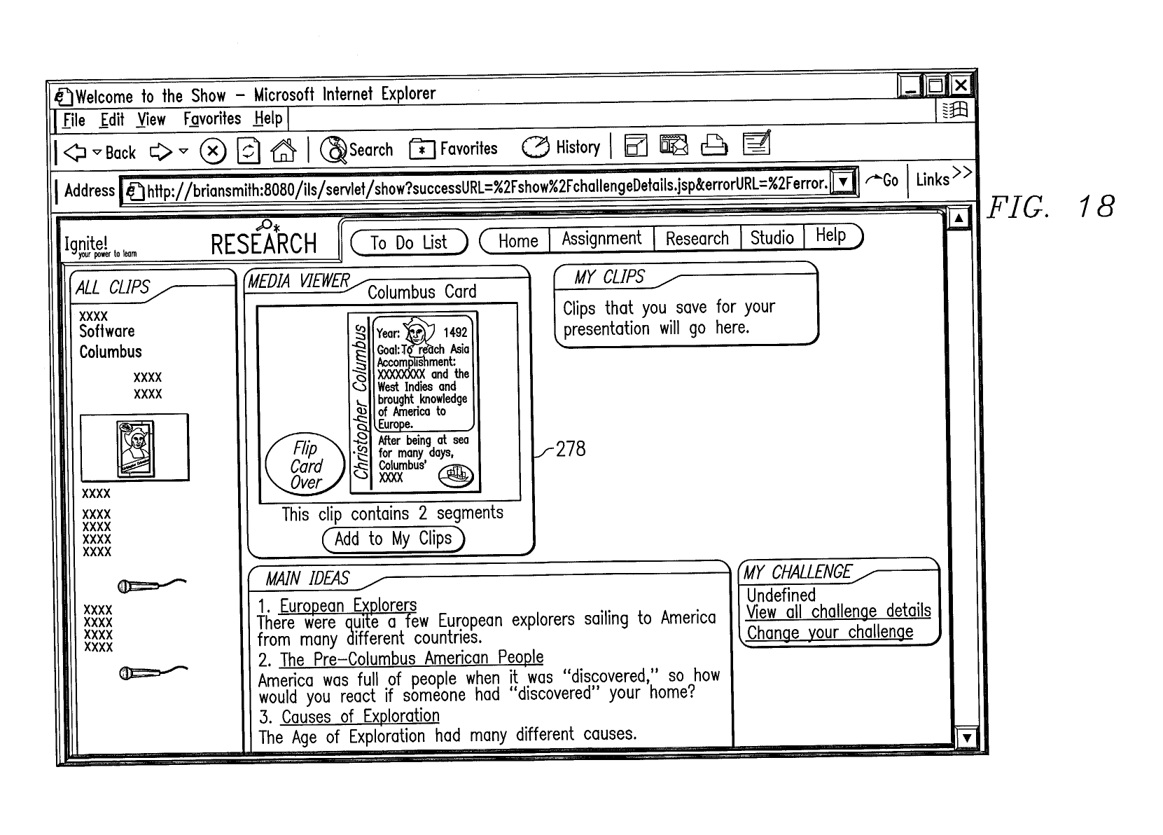

FIG. 16 shows an example of the next screen 271 that learner may see after accepting the challenge as suggested by FIG. 15. FIG. 16 shows that the learner has selected the Protest and Rebellion challenge. The learner is further directed to recruit people for his side of a protest, provide a way that the learner can find out what protester or rebellion from a colonial area of his interest, attract people to join his cause and take part in the rebellion and collect and make media to use in the presentation. Moreover, the screen illustrates or explains to the learner what a protest is, by definition, as indicated in FIG. 16, and then further gives the examples of protest such as Bacon's Rebellion, Pontiac's Rebellion, and the actions of Mary Dyer, as ell as further describing some of the ways in which this rebellion has been described in the material that the learner may access. Screen 271 of FIG. 16 directs the learner to imagine that he would have done to get others to join his protest and provides the ability to further click on to accept this challenge or to return back to the screen 261 of FIG. 15.

The present invention, once the challenge is accepted, provides to the learner a menu as shown in FIG. 17. FIG. 17 shows research screen 281 that includes at the top a To Do list that the learner may select as indicated by button 270. Menu 272 permits returning to home, returning to assignment, conducting more research, ongoing to the studio for assembling and editing presentation or obtaining help at the particular information. In addition, the research screen shows icon 274 that illustrates “My Clips” as referred to in block 194 in FIG. 11. This is a place where the learner can select a media and then restore that media for use in the studio text creator section of the process. The all clips block 276 provides to the learner a menu of clips. In the illustration of FIG. 17, there is a demonstration of the media relating to the subject or subtopic of Christopher Columbus and the all clips section provides a menu describing the type of media that the learner may access. This may include audio media or visual media or textual media all of the media being tagged consistent with the modality vector such as vector 150 described in FIG. 4.

In FIG. 17, further there is provided a viewer window that gives a more complete demonstration of the media and at window 278. Associated with 278 are the main ideas 280 and My Challenge 282. The main idea 280 illustrates the main ideas of the media that is being viewed. They example of FIG. 17 shows that to the Columbus media, the main ideas include “European explorers”, “pre-Columbus” and “causes of exploration.” This, in addition to each of these topics, there is provided in general a main idea associated with the media. Of particular note, there is the fact that the media is done so in a way consistent with some of the styles that are topical or current in today's parlance. For example. The Christopher Columbus Card media is provided in a form of a trading card, such as might be of particularly attractive in today's learner learners who are active in same types of trading cards.

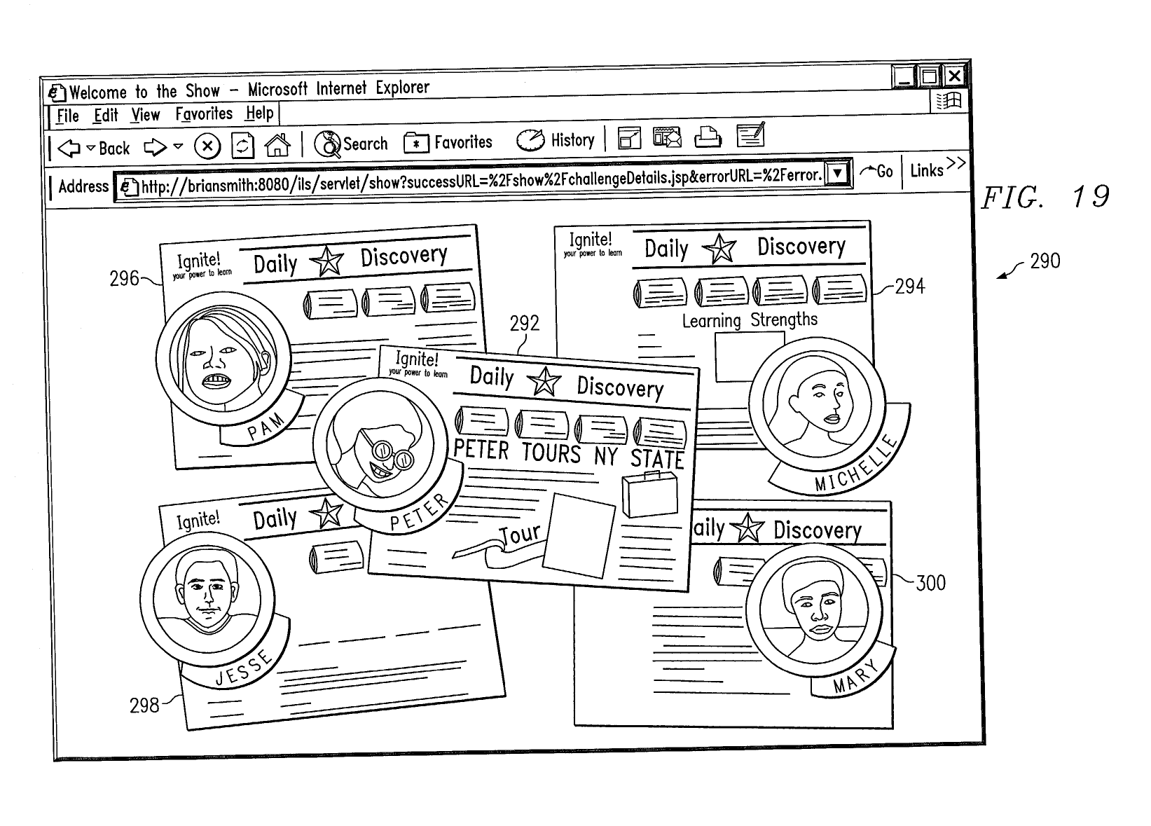

FIG. 18 further demonstrates the trading card aspects of the media appearing in FIG. 17. In FIG. 18, the Columbus Card media is “turned over” graphically to indicate on the back of the card information of the same type as a baseball or Pokemon trading card. This include information such as Columbus' lifespan and key facts relevant to his voyage to the Americas.

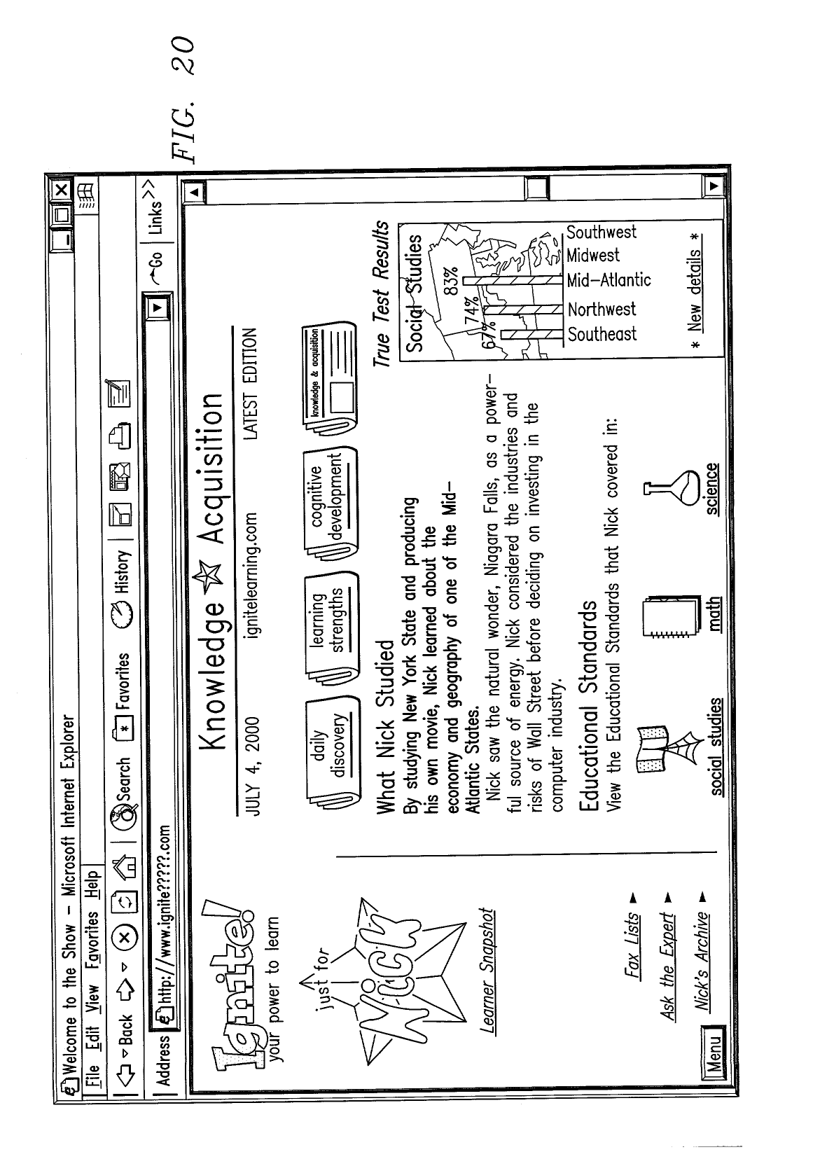

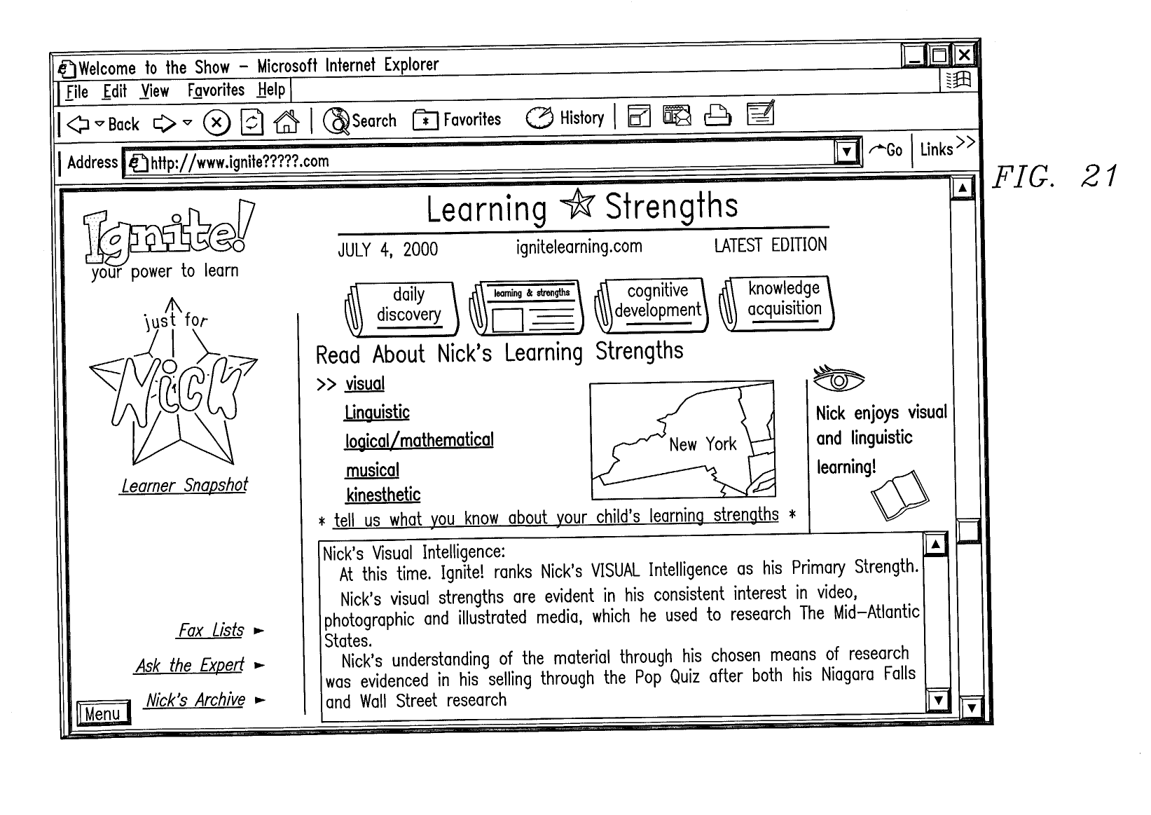

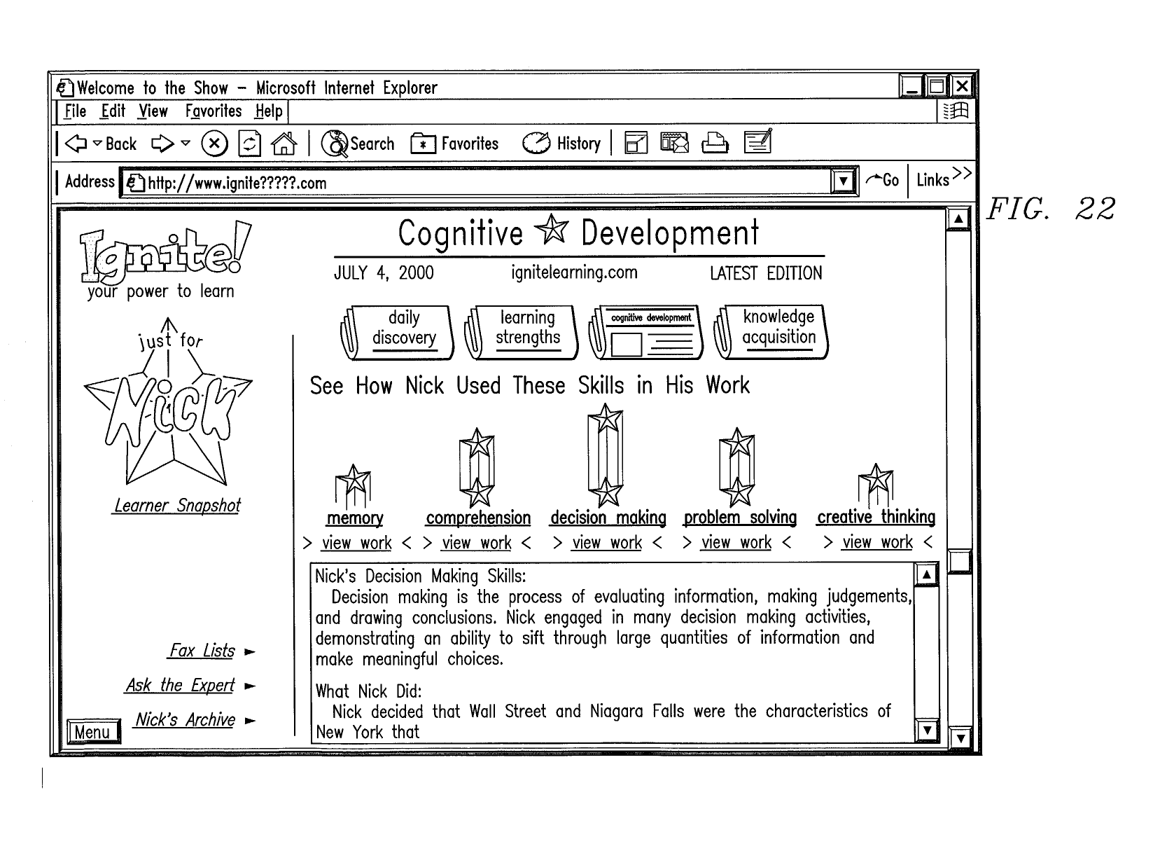

FIGS. 19 through 22 show examples of the types of reports that the present invention makes possible. In particular, FIG. 19 shows a composite screen 290 that depicts that the learner Peter has toured New York using graphic 292. Upon clicking graphic 292 (see also FIG. 20), the reviewer can learn additional information regarding the work completed by the learner and the scope of constructive project completed. Screen 290 (see also, FIG. 21) also includes graphic 294 that allows the reviewer to view the learning strengths exhibited by a learner, here Michele, in performing a particular constructive desired result. Graphic 296 allows the reviewer to access further the types of information and the learning objectives that were accomplished in the constructive challenge undertaking by a learner, here Pam. Skills applications assessments are reported by the present invention via graphic 298 (see also, FIG. 22), which for here reports the assessments for learner Jesse. Finally, the present invention may show additional information of a variety of types for other learners, all consistent with the object of demonstrating that both learning objectives and constructive desired results have been taught through the use of the present invention.

FIG. 19 shows the reports that result from the feedback that a student might generate, that may be generated by the present invention and consistent to report the results of the student's success in generating a particular project. The reports that the present invention provides relating to the project are child specific. These reports will indicate what the student has been working on. The reports indicate in detail what the student accomplished in preparing the report. It further describes the learning strengths that the student demonstrated in preparing the report. For example, in addressing or explaining the learning strength of the individual, the present invention will provide some detail justification to show that the learner is a more of a visual or kinesthetic learner than a linguistic learner if that happens to be the case with the particular learner.

Although the present invention has been described in detail, it should be understood that various changes, substitutions and alterations can be made hereto without departing from the spirit and scope of the invention as defined by the appended claims.

At Block 192 there is a FIG. 11, there is provided a 20 second preview of the information that the student will learn as he proceeds through the student interaction phase.

The challenge is an argument that the student makes to support a particular position. The purpose of the presentation is to go through the research topic, but for the purpose of supporting the particular position that is responsive to the challenge identified in Block 192.

In the research screen as indicated in Block 194, all of the media lies. As the Christopher Columbus card indicates, the media itself is more of a linguistic piece, and so its vector value at the linguistic level will be higher than at the auditory or kinesthetic level. In addition, the image of Christopher Columbus has a significant visual part. Likewise, at the visual value of the vector, the lodality(?) vector, there will be a higher value for the visual piece, of the visual proclivity, the visual modality than will be existing for the kinesthetic or musical/logical proclivity, preferred embodiment.

Most medial has at least two high scores for modality values.

Thus, a single piece of media will more than likely have a significant visual modality as well as a linguistic modality, for example. There may be music pieces that have a higher music modality value. These pieces, however, often will include the lyrics or text associated with the music so that there will be a similarly high value for the linguistic modality for that particular piece.

In the selection of a challenge as Block 194 indicates, the challenge that the particular answer(?) selects will be suggested through the modality proclivity that the user possesses or the student possesses. For example, in, if the student selects the creation or solving of a physical puzzle, then that would be suggestive of identifying the user, or the student as having a proclivity toward the kinesthetic modality. Moreover, as the student creates the clips or the information that will be used in the studio text creator 204, that selection that occurs in Block 194 by its use will be examined by the adaptive learning engine as Hexicon 196 indicates. This will further establish both the proclivity of the student as well as adapt the particular media to consistent with the type of modality proclivity previously demonstrated by the particular student as discussed above. Moreover, as the student creates the presentation, i.e. studio text creator, an even stronger interaction occurs with the adaptive learning engine, as Block 204 indicates. By interfacing with the student more strongly at the studio text creator Block 204, as indicated by Hexicon 206, the present invention will be interfacing at the most creative point in the learning process for the particular student. This interaction at the most creative point with the student would be more likely than in the earlier selected phases, Block 192 and Block 194, to demonstrate the different modality proclivities that the student may possess.

A particularly important aspect of Forced Tour 102 of FIG. 11 is that it forces the student to become aware of the information that may not have been reviewed by the student by virtue of the student choosing information that was of a certain modality to the, and that information would not include the necessary information that would be disclosed in the Forced Tour step 202. Moreover, it ensures that the student is exposed to information of other modalities, thus helping the student to improve his awareness if not the proclivity of the material using the other modalities.

In the event that a user takes multiple copies of the same media, there should, the present invention has the propensity to not give the replicated selection of the same media a double or triple or more waiting(?), the idea being that the proclivity has been demonstrated by the initial selection of the media. Further uses or selections of particular media result in little if any persuasive demonstration of yet a further increased modality as compared to what might be demonstrated with the selection of other media.

A technical advantage of the present invention is that it tightly binds the presentation of curriculum with the modality proclivity of a particular learner. This tight binding between the content to be presented and the modality proclivity is further dynamic and adjust as both the student and the media adjust with users over time.

The first formula provides the means to find the “closest fit” between the profile of the students learning proclivities and a specified “content object” that has a profile of matching attributes. (e.g. linguistic, mathematical, kinesthetic, etc.)

Its intended purpose is to deliver to an learner “media content” with the greatest affinity for the learning proclivities of that individual student.

The formula is adequate for the purposes of delivering content congruent to the learning proclivities of the student.

The second formula provides the basis of the core value proposition of the present invention, is the formula that provides for adaptation.

The key understanding necessary to appreciate the operation of the adaptation formula is that the multi-attribute profile of a program packet (e.g., a selected piece of media or a specific sequence of student activities) is in fact an aggregated history of the multi-attribute profiles of all students who have previously completed the specified sequence of actions. In other words, the program packet profile represents the profile of the typical student that engages in the packet's activities.

Adaptation is bi-directional in that the “program packet profile” and the student vector are both “adapted” by the interaction. The profile of a specific student is thus shaped and honed by the activities of all the students in the present system before them. A student profile therefore reflects the profile of all the students that have completed the same set of activities before them.

Finally, all the attributes of the profile of both the program packet and the student are “adapted” when adaptation occurs. This approach uses all the information in the profile: both the values of the individual learning attributes themselves and the relationships that exist among the attributes of the profile. Consequently, a well-defined test for one learning attribute has the possibility to provide real information on the remaining attributes.

The present invention provides information in a tailored way for the particular type of modality proclivity of a given learner. The present system and method address all relevant types of modalities or learners consistent with the material being presented. Upon recognizing that a learner has a particular type of learning style, the present system provides to the learner at the beginning of a learning session information in a manner most appropriate for the modality or the proclivity of the learner. The order in which the system presents material to learner particularly benefits the learners' learning mode. The remaining modalities for the presentation of material are provided to the learner, however, after the most accessible mode is first used the learner may, for example, learn best in an auditory mode. The present invention, therefore, will first provide information on a particular subject through an auditory modality as opposed to a kinesthetic or a linguistic modality.

By first tailoring the information according to the most accessible or readily understood learning modality, the present invention makes it possible to present additional or other types of information. This is because the learner has already experienced or grasped basic ideas relating to the subject matter through the most readily or easily usable modality for that learner. By using this most accessible modality first, the present invention makes the other less easily accessible modalities more readily useable by the learner. Thus, for example, a learner may be more interested or more likely to read about a particular historical FIGURE or subject if that learner, who may be a visual learner, has seen a movie about the subject prior to reading the textual material.

The present invention uses accepted adaptive learning algorithms for determining the modality proclivity that a person demonstrates. This facilitates both the understanding of the type of material that might be best presented to a learner, as well as the proclivity of the learner, him or himself.

The present invention has the ability to expand beyond the presently-accepted major areas of learning modalities. The modalities may include auditory, linguistic, kinesthetic, musically, mathematical, or logical modalities. The preferred embodiment of the present invention makes use of these five learning modalities. It has, in addition, the ability to expand to many other intelligences that a learner may demonstrate. Therefore, the present invention has the ability to be useful for an ever-expanding array of different types of learners.

The present invention promotes learning in a constructivist manner. That is, it presents information in a manner more consistent with how a learner might learn information outside of a classroom environment. By presenting a particular challenge and an array of tools to address the particular challenge, the present invention presents material in a manner consistent with the individual learner's modality proclivity. The present invention, therefore, improves the ability to more readily or even immediately make use of new information for the purpose of learning how that information might be applicable to the learner.

The user builds his own base of knowledge and experience with a particular type of information or class of information in a practical way. By dealing with the information in this constructivist manner, the learner masters the material more permanently and more completely than when the information is provided in a non-constructivist or a didactic manner.

The present invention uses continual feedback and monitoring of not only the learning of the individual material as well as learns ability to experience all modalities of learning. The present invention ensures a much more robust learning experience at the individual level. Because the present invention identifies that all modalities of learning and all relevant subject matter is learned by the learner, there is the assistance and the present assists in making certain that the learning process is as complete as possible. The differences in what the student experiences are also recorded via reports for use by the teacher as well as, in the case of teaching grammar school children students, the present invention provides reports that are useful by the parents or guardians of the children. This further enhances an involvement in the learning process to the benefit of the students and the parents as a whole.

The present invention provides for real time or dynamic updating of content that a student may use in the constructive learning process. In one embodiment, for example, this dynamic updating of information may in fact be tailored to the particular learning modality proclivities of the students. That is, if a student, for example, demonstrates a particular auditory learning modality proclivity then the update of the information for the construction of a particular project might be or could be, consistent with the teachings for the present invention, If the information or supplemental information is of a more auditory character than supplemental information might be provided of a is more auditory character than a linguistic character. Such a need for updating, however, would necessarily include the need to expose the student to the other necessary modalities for learning a particular subject consistent with the predetermined learning objectives.

Still another technical advantage of the present invention is that it provides for a learning process that is non-linear versus the linear or serial learning methodology of a textbook. The present invention provides for the reinforcement of information. By the act of testing in real time the present invention has the ability to facilitate the users drawing of information from different sources in a non-linear fashion that provides a richer, more robust learning experience than does the serial or step-by-step learning process that is typical of most textbook learning processes. The present invention, therefore, permits the navigation of information for the purpose of constructing a particular predetermined result. Such a result may be to persuade a teacher or recipient of a project of a particular position or hypothesis that would be demonstrative of mastering the relevant subject matter.

What is claimed is:

1. A method for performing constructive, modality-focused learning, comprising the steps of:
storing a collection of multi-media content segments in a database, the multimedia content having an associated learning modality tag profile;
assigning a learning modality proclivity profile to a learner for reflecting the learning modality proclivity demonstrated by the learner;
presenting to the learner a constructive learning challenge, said constructive learning challenge formed so as to demonstrate the accomplishment of predetermined learning objectives and require the learner to construct a result, presenting for selection by the learner, the collection of multi-media content segments for responding to said constructive learning challenge;
adapting said learning modality proclivity profiles, the learning modality profile tag in response to the demonstrated proclivity of the learner in accomplishing said predetermined learning objective and constructing said desired result, and verifying the accomplishment of said predetermined learning objectives and the construction of said desired result.
